(19) United States
(12) Patent Application Publication
(10) Pub. No.: US 2010/0328364 A1
(43) Pub. Date: Dec. 30, 2010

(54) METHOD OF DRIVING LIGHT EMITTING DEVICE, LIGHT EMITTING DEVICE AND ELECTRONIC APPARATUS

(75) Inventor: Takehiko KUBOTA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/793,265

(22) Filed: Jun. 3, 2010

(30) Foreign Application Priority Data
Jun. 26, 2009 (JP) 2009-151876

(51) Int. Cl. G09G 5/10

(52) U.S. Cl. 345/690

(57) ABSTRACT

A method of driving a light emitting device in a first light emitting period, supplying electric charge to the light emitting element of a target pixel circuit of the plurality of pixel circuits. In this case, the electric charge has been generated by supplying the gradation potential to the signal line. In a charging period after the first light emitting period, in order for a reverse bias to be applied to light emitting elements of control pixel circuits other than the target pixel circuit of the plurality of pixel circuits, the method further includes changing potentials of the potential lines corresponding to the control pixel circuits. In a second light emitting period after the charging period, the method further includes supplying electric charge generated in the charging period to the light emitting element of the target pixel circuit.

### BACKGROUND

1. Technical Field

The present invention relates to a technique of driving a light emitting element, such as an organic electroluminescence (EL) element.

2. Related Art

Techniques have been proposed in which a gradation (luminance) of a light emitting element is controlled by adjusting a current supplied to the light emitting element. For example, JP-A-2006-3716 discloses a technique in which electric charge in accordance with a specified gradation is held in a capacitive element of each pixel circuit, and the electric charge is supplied from the capacitive element to a light emitting element, so that the light emitting element emits light. In the technique of JP-A-2006-3716, use of a driving transistor is not required for adjusting a current supplied to the light emitting element. Therefore, one advantage of the technique is that errors in gradation due to characteristics (e.g., a threshold and mobility) of a driving transistor can be suppressed.

However, in order for each light emitting element to emit a sufficient amount of light with the technique of JP-A-2006-3716, a capacitive element having a large capacitance needs to be integrated in a pixel circuit. Accordingly, the technique has a problem that the possibility of short-circuit between both electrodes of the capacitive element increases (the yield decreases), and has another problem that an increased area of a pixel circuit makes it difficult to achieve high precision.

### SUMMARY

An advantage of some aspects of the invention is that both securing of the amount of light of a light emitting element and downsizing of a pixel circuit (capacitor) can be achieved by using a configuration in which electric charge held in a capacitor is supplied in order to cause the light emitting element to emit light.

To solve the foregoing problems, there is provided a method according to a first aspect of the invention of driving a light emitting device which includes a signal line supplied with a gradation potential in accordance with a specified gradation, a plurality of pixel circuits each having a light emitting element which emits light in accordance with a current between a first electrode and a second electrode, and a plurality of potential lines connected to the second electrodes of the respective light emitting element. The method includes, in a first light emitting period, supplying electric charge to the light emitting element of a target pixel circuit of the plurality of pixel circuits, the electric charge having been generated by supplying the gradation potential to the signal line; in a charging period after the first light emitting period, in order for a reverse bias to be applied to light emitting elements of control pixel circuits other than the target pixel circuit of the plurality of pixel circuits, changing potentials of the potential lines corresponding to the control pixel circuits; and, in a second light emitting period after the charging period, supplying electric charge generated in the charging period to the light emitting element of the target pixel circuit.

In the above driving method, electric charge in accordance with a gradation potential is supplied to the light emitting element of the target pixel circuit in the first light emitting period, and electric charge generated by changing potentials of potential lines of control pixel circuits in the charging period is supplied in the second light emitting period. That is, the light emitting element of the target pixel circuit emits light twice, in the first light emitting period and the second light emitting period. Accordingly, there is an advantage that the amount of light of the light emitting element can be sufficiently secured even when a capacitor for holding electric charge supplied to the light emitting element of the target pixel circuit is small.

Any position and any configuration are accepted for a capacitor for holding electric charge supplied to the light emitting element of the target pixel circuit in the second light emitting period. For example, in a configuration in which each pixel circuit may include a first capacitor having a first capacitor electrode connected to a path linking the signal line and the first electrode, and a second capacitor electrode, electric charge held in the first capacitors of the control pixel circuits may be supplied through the signal line to the light emitting element of the target pixel circuit in each of the first light emitting period and the second light emitting period. Since providing the first capacitor is relatively easy, there is an advantage that the amount of electric charge (luminance of a light emitting element) supplied to the light emitting element of the target pixel circuit is easily secured.

In a configuration in which each pixel circuit may include a second capacitor (e.g., parasitic capacitance) associated with the light emitting element, electric charge held in the second capacitors of the control pixel circuits in the charging period may be supplied through the signal line to the light emitting element of the target pixel circuit in the second light emitting period. In the above configuration, electric charge supplied to the light emitting element of the target pixel circuit is held in the second capacitor of the light emitting element. This makes it possible to downsize or remove a capacitor which is to be positively formed in order to hold electric charge.

Further, a method of utilizing a third capacitor associated with the signal line for holding electric charge is preferable. Specifically, in the charging period, the first electrodes of the control pixel circuits are connected to the signal line, so that electric charge is held in the third capacitor of the signal line, and the electric charge held in the third capacitor of the signal line is supplied to the light emitting element of the target pixel circuit in the second light emitting period. In the above configuration, electric charge supplied to the light emitting element of the target pixel circuit is held in the third capacitor of the signal line. This makes it possible to downsize or remove a capacitor which is to be positively formed in order to hold electric charge.

In a preferable method of driving a light emitting device, each of the plurality of pixel circuits includes a first capacitor having a first capacitor electrode and a second capacitor electrode, a first switch (e.g., a switch SW1 illustrated in FIG. 2) disposed between the first capacitor electrode and the first electrode, and a second switch (e.g., a switch SW2 illustrated in FIG. 2) disposed between the first capacitor electrode and the signal line. In the preferable driving method, in a writing period before the start of the first light emitting period, the first switches of the control pixel circuits are controlled to be in an OFF state, and the second switches of the control pixel circuits are controlled to be in an ON state. Further, in the first light emitting period, the first switches of the control pixel circuits are controlled to be in the OFF state and the second switches of the control pixel circuits are controlled to be in the ON state, and the first switch and the second switch of the target pixel circuit are controlled to be in the ON state. Further, in the second light emitting period, the second switches of the control pixel circuits are controlled to be in the ON state, and the first switch and the second switch of the target pixel circuit are controlled to be in the ON state.

With the above driving method, in the writing period, the first switches of the control pixel circuits are controlled to be in the OFF state, which blocks light emission of the light emitting elements of the control pixel circuits, whereas the second switches of the control pixel circuits are controlled to be in the ON state, so that electric charge in accordance with a gradation potential is held in the first capacitors of the control pixel circuits. In the first light emitting period, the first switch and the second switch of the target pixel circuit are controlled to be in the ON state, so that electric charge of the first capacitors of the control pixel circuits is supplied to the light emitting element of the target pixel circuit. In the second light emitting period, the second switches of the control pixel circuits are controlled to be in the ON state, and the first switch and the second switch of the target pixel circuit are controlled to be in the ON state, so that electric charge generated by changing potentials of potential lines in the charging period is supplied to the light emitting element of the target pixel circuit.

In a driving method according to a preferable embodiment of the invention, in the charging period, the first switches of the control pixel circuits are controlled to be in the ON state. In the above method, since the first capacitor electrodes of the first capacitors in the control pixel circuits are connected to the first electrodes of the light emitting elements in the charging period, electric charge in accordance with the change of potentials of the potential lines of the control pixel circuits is held in the first capacitors of the control pixel circuits. Accordingly, there is an advantage that the amount of electric charge (luminance of the light emitting element) supplied to the light emitting element of the target pixel circuit is sufficiently secured in the second light emitting period.

In a driving method according to a preferable embodiment of the invention, in the charging period, the second switches of the control pixel circuits are controlled to be in the ON state. In the above method, since the signal line is connected to the first electrodes of the light emitting elements of the control pixel circuits, electric charge in accordance with the change of potentials of the potential lines of the control pixel circuits is held in the first capacitors of the control pixel circuits and in the third capacitor (parasitic capacitance) of the signal line. Accordingly, an advantageous effect that the amount of electric charge supplied to the light emitting element (luminance of the light emitting element) of the target pixel circuit is sufficiently secured in the second light emitting period becomes particularly marked. Note that specific examples of the above methods will be described later, for example, as a second embodiment.

In a driving method according to a preferable embodiment of the invention, in the charging period, the second switches of the target pixel circuit and the control pixel circuits are controlled to be in the OFF state, and then the first switches of the control pixel circuits are controlled to be in the ON state. In the above method, at a time point at which the first switches of the control pixel circuits are controlled to be in the ON state, the second switches of the target pixel circuit and the control pixel circuits have been controlled to be in the OFF state. Therefore, there is an advantage that the possibility of supplying noise caused by the operation of the first switches of the control pixel circuits to the light emitting element of the target pixel circuit (i.e., the possibility of erroneous light emission of the light emitting element of the target pixel circuit) is reduced.

In a driving method according to a preferable embodiment of the invention, in the charging period, the potentials of the potential lines corresponding to the control pixel circuits are changed from a first potential to a second potential. Further, in the second light emitting period, the potentials are maintained at the second potential. Further, in an initialization period after the second light emitting period, the potentials are changed to the first potential after the first switches of the control pixel circuits and the target pixel circuit are controlled to be in the OFF state. In the above method, at a time point at which the potentials of the potential lines are changed from the second potential to the first potential, the first switches of the control pixel circuits and the target pixel circuit have been controlled to be in the OFF state. Therefore, the above method has an advantage that the possibility of supplying noise generated, for example, in the signal line to the light emitting elements of the control pixel circuits (i.e., the possibility of erroneous light emission of the light emitting elements of the control pixel circuits) is reduced.

In a driving method according to a preferable embodiment of the invention, the second switch of each pixel circuit is kept in the ON state from an end point of the second light emitting period to an end point of the first light emitting period corresponding to another target pixel circuit. In the above method, the number of operations of the second switch is decreased compared to a configuration in which the state of the second switch of each pixel circuit is changed to the OFF state within a period from the end point of the second light emitting period to the end point of the next first light emitting period. Accordingly, there is an advantage that the number of times charging and discharging a line is performed so as to control the second switch is decreased (which leads to reduction in power consumption of a circuit which drives the second switch).

In a driving method according to a preferable embodiment of the invention, in the charging period, the potentials of the potential lines corresponding to the control pixel circuits are changed from the first potential to a second potential which is set to be variable. In the charging period, electric charge corresponding to the second potential is generated, and therefore, in the above embodiment, it is possible to adjust luminance of each light emitting element in accordance with the variable second potential. Note that a specific example of the above method will be described later, for example, as a third embodiment.

In a driving method according to a preferable embodiment of the invention, among the plurality of pixel circuits, a variably set number of pixel circuits are the control pixel circuits. The amount of electric charge supplied to the light emitting element of the target pixel circuit in the second light emitting period varies in accordance with the number of control pixel circuits. Therefore, in the above embodiment, it is possible to adjust luminance of each light emitting element in accordance with a variable number of control pixel circuits. Note that a specific example of the above method will be described later, for example, as a fourth embodiment.

An aspect of the invention is specified as a light emitting device including a drive circuit which implements the above driving method. A light emitting device according to a second aspect of the invention includes a signal line supplied with a gradation potential in accordance with a specified gradation, a plurality of pixel circuits each including a light emitting element which emits light in accordance with a current between a first electrode and a second electrode, a plurality of potential lines connected to the second electrodes of the respective light emitting elements, and a drive circuit for driving each of the plurality of pixel circuits. In a first light emitting period, the drive circuit supplies electric charge to the light emitting element of a target pixel circuit of the plurality of pixel circuits. In this case, the electric charge has been generated by supplying the gradation potential to the signal line. In a charging period after the first light emitting period, in order for a reverse bias to be applied to light emitting elements of control pixel circuits other than the target pixel circuit of the plurality of pixel circuits, the drive circuit changes potentials of the potential lines corresponding to the control pixel circuits. In a second light emitting period after the charging period, the drive circuit supplies the electric charge generated in the charging period to the light emitting element of the target pixel circuit. According to a light emitting device with the above configuration, actions and advantageous effects similar to those with a driving method according to the first aspect of the invention are achieved.

The light emitting device according to the second aspect of the invention is utilized for various electronic apparatuses. Typical examples of the electronic apparatuses are devices utilizing the light emitting devices as display devices. As an electronic apparatus according to a third aspect of the invention, a personal computer and a cellular phone are exemplified. However, applications of the light emitting device according to the second aspect of the invention are not limited to display of images. For example, the light emitting device according to the second aspect of the invention may be utilized as an exposure device (optical head) for forming a latent image on an image carrier, such as a photosensitive drum, by irradiation with light beams.

### BRIEF DESCRIPTION OF THE DRAWINGS

The invention will be described with reference to the accompanying drawings, wherein like numbers reference like elements.

FIG. 1 is a block diagram of a light emitting device according to a first embodiment of the invention.

FIG. 2 is a circuit diagram of a pixel circuit.

FIG. 3 is a timing chart of the operation of the light emitting device.

FIG. 4 is a conceptual diagram illustrating a state of pixel circuits in the n-th column in a writing period.

FIG. 5 is a conceptual diagram illustrating a state of pixel circuits in the n-th column in a first light emitting period.

FIG. 6 is a conceptual diagram illustrating a state of pixel circuits in the n-th column in a charging period.

FIG. 7 is a conceptual diagram illustrating a state of pixel circuits in the nth column in a second light emitting period.

FIG. 8 is a conceptual diagram illustrating a state of pixel circuits in the n-th column in an initialization period.

FIG. 9 is a timing chart of the operation of a light emitting device in a second embodiment.

FIG. 10 is a conceptual diagram illustrating a state of pixel circuits in the n-th column in the charging period in the second embodiment.

FIG. 11 is a block diagram of a potential control circuit in a third embodiment.

FIG. 12 is a block diagram of a potential control circuit in a fourth embodiment.

FIG. 13 is a timing chart of the operation of a light emitting device according to the fourth embodiment.

FIG. 14 is a timing chart of the operation of a light emitting device according to the fourth embodiment.

FIG. 15 is a conceptual diagram illustrating a state of pixel circuits in the n-th column in the second light emitting period in the fourth embodiment.

FIG. 16 is a circuit diagram of a pixel circuit in a fifth embodiment.

FIG. 17 is a timing chart of the operation of a light emitting device in the fifth embodiment.

FIG. 18 is a conceptual diagram illustrating a state of pixel circuits in the n-th column in the writing period in the fifth embodiment.

FIG. 19 is a conceptual diagram illustrating a state of the pixel circuits in the n-th column in the first light emitting period in the fifth embodiment.

FIG. 20 is a conceptual diagram illustrating a state of the pixel circuits in the nth column in the charging period in the fifth embodiment.

FIG. 21 is a conceptual diagram illustrating a state of the pixel circuits in the n-th column in the second light emitting period in the fifth embodiment.

FIG. 22 is a conceptual diagram illustrating a state of the pixel circuits in the n-th column in the initialization period in the fifth embodiment.

FIG. 23 is a circuit diagram of a pixel circuit according to a modification.

FIG. 24 is a perspective view of an electronic apparatus (personal computer).

FIG. 25 is a perspective view of an electronic apparatus (cellular phone).

FIG. 26 is a perspective view of an electronic apparatus (personal digital assistant).

### DESCRIPTION OF EXEMPLARY EMBODIMENTS

### A: First Embodiment

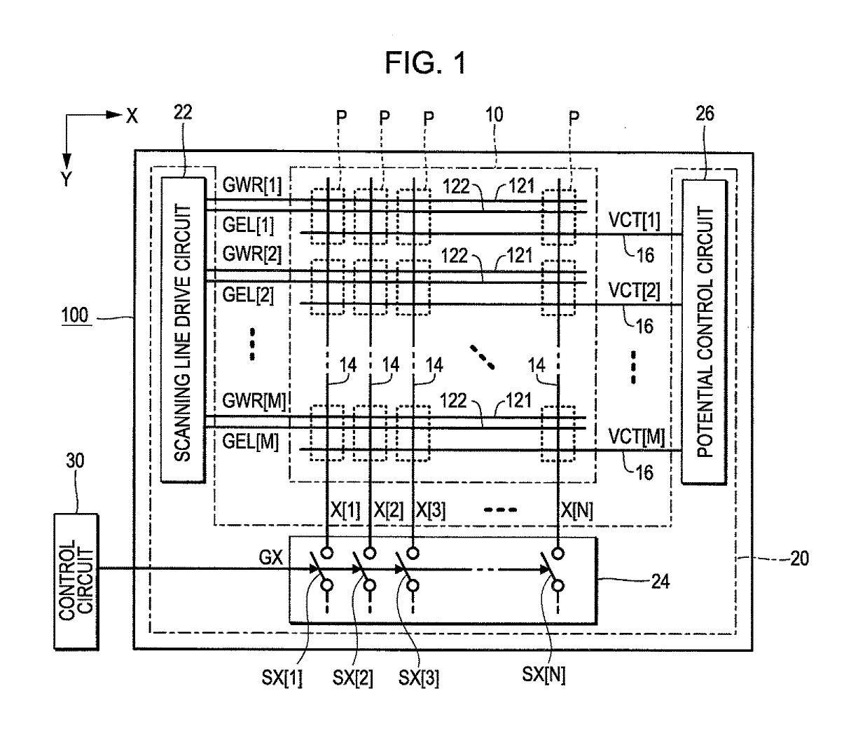

FIG. 1 is a block diagram of a light emitting device 100 according to the first embodiment of the invention. The light emitting device 100 is mounted, as a display for displaying an image, on various electronic apparatuses. As illustrated in FIG. 1, the light emitting device 100 includes an element section (display area) 10 in which a plurality of pixel circuits P are arranged, a drive circuit 20 which drives pixel circuits P to display an image in the element section 10, and a control circuit 30 that controls the drive circuit 20. The drive circuit 20 is configured to include a scanning line drive circuit 22, a signal line drive circuit 24 and a potential control circuit 26. Note that the drive circuit 20 may be made up of a plurality of integrated circuits (chips).

Formed in the element section 10 are M scanning lines 121 extending in the X-axis direction, M control lines 122 extending in the X-axis direction to be paired with the scanning lines 121, and N signal lines (data lines) extending in the Y-axis direction, which intersects with the X-axis direction (M and N are natural numbers). The plurality of pixel circuits P are arranged in a matrix M rows long×N columns wide so as to correspond to intersections of the scanning lines 121 and signal lines 14. In the element section 10, M potential lines 16 extending in the X-axis direction, together with the scanning lines 121 and the control lines 122, are formed.

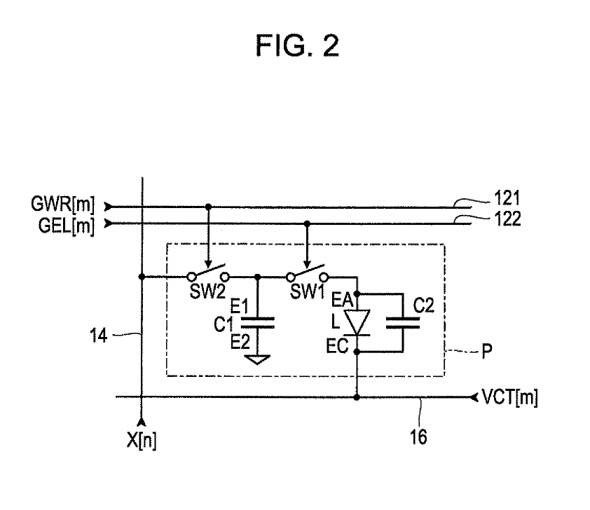

FIG. 2 is a circuit diagram of the pixel circuit P. In FIG. 2, one pixel circuit P located at an m-th row (m=1 to M) and an n-th column (n=1 to N) is representatively illustrated. As illustrated in FIG. 2, the pixel circuit P is configured to include a light emitting element L, the switch SW1, the switch SW2 and a capacitor C1. The light emitting element L is a current drive element, which emits light with luminance in accordance with the magnitude (amount of electric charge) of a current that flows between an electrode EA and an electrode EC facing each other. An organic EL element in which a light emitting layer formed of an organic EL material is interposed between the electrode EA and the electrode EC is preferably employed as the light emitting element L. The electrode EA is the anode, and the electrode EC is the cathode. The electrodes EC of the light emitting elements L of N pixel circuits P in the m-th row are commonly connected to the potential line 16 in the m-th row. As illustrated in FIG. 2, a capacitor (parasitic capacitance) C2 is associated with the light emitting element L.

The capacitor C1 is a capacitive element having a structure in which a dielectric substance is interposed between a capacitor electrode E1 and a capacitor electrode E2, and functions as an element which holds electric charge. The capacitor electrode E2 is connected to a line (e.g., a capacitive line formed commonly over the pixel circuits P in the element section 10) supplied with a given potential.

The switch SW1 is disposed between the capacitor electrode E1 and the electrode EA of the light emitting element L, and controls electric connection (conduction/nonconduction) therebetween. The switch SW2 is disposed between the capacitor electrode E1 and the signal line 14 in the n-th column, and controls electric connection therebetween. That is, the switch SW1 and the switch SW2 function as elements for controlling electric connection of the electrode EA of the light emitting element L with the signal line 14 in the nth column. The switches SW1 and SW2 are made of, for example, thin film transistors formed on the surface of a substrate. A gate of the switch SW1 in each of N pixel circuits P in the m-th row is connected to the control line 122 in the m-th row. A gate of the switch SW2 in each of N pixel circuits P in the m-th row is connected to the scanning line 121 in the m-th row.

The control circuit 30 illustrated in FIG. 1 controls the drive circuit 20 by outputting various kinds of signals (e.g., a synchronizing signal). The scanning line drive circuit 22 generates scanning signals GWR[1] to GWR[M] and outputs them to the respective scanning lines 121, and generates control signals GEL[1] to GEL[M] and outputs them to the respective control lines 122. Note that another configuration may be employed in which a circuit of generating the scanning signals GWR[1] to GWR[M] and a circuit of generating the control signals GEL[1] to GEL[M] are separately arranged. The potential control circuit 26 generates potentials VCT[1] to VCT[M] and outputs them to the respective potential lines 16.

The signal line drive circuit 24 generates gradation potentials X[1] to X[N] in accordance with specified gradations for the pixel circuits P, and outputs the gradation potentials X[1] to X[N] to the respective signal lines 14. The specified gradation for each pixel circuit P is specified in an image signal supplied from the control circuit 30. As illustrated in FIG. 1, the signal line drive circuit 24 includes N switches SX[1] to SX[N] corresponding to the signal lines 14 which are different from one another. A switch SX[n] controls whether or not to output a gradation potential X[n] to the signal line 14 the n-th column (conduction/nonconduction between the signal line 14 in the n-th column and the signal line drive circuit 24). Supplied to gates of the switches SX[1] to SX[N] is a common, control signal GX from the control circuit 30.

The drive circuit 20 drives the pixel circuits P sequentially, row by row. Specifically, in a horizontal scanning period H[m] among M horizontal scanning periods H[1] to H[M] obtained by dividing each vertical scanning period (field period), the drive circuit 20 causes the light emitting element L of each (hereinafter sometimes referred to as a “target pixel circuit PA”) of N pixel circuits P in the m-th row to emit light.

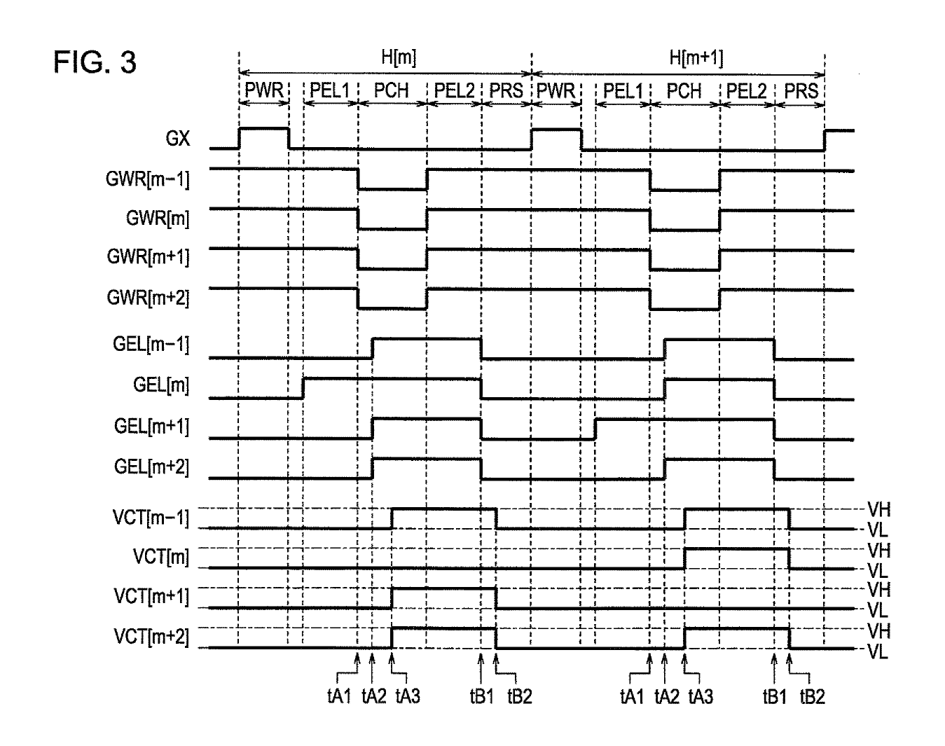

As illustrated in FIG. 3, the horizontal scanning period H[m] includes the writing period PWR, the first light emitting period PEL1, a charging period PCH, a second light emitting period PEL2 and an initialization period PRS. For the sake of convenience in description, the operation of the light emitting device 100 is given below, with attention paid to each pixel circuit P in the n-th column in each of the periods in the horizontal scanning period H[m]. The operation to be described below is performed in parallel on every column in each of the horizontal scanning periods H[1] to H[M].

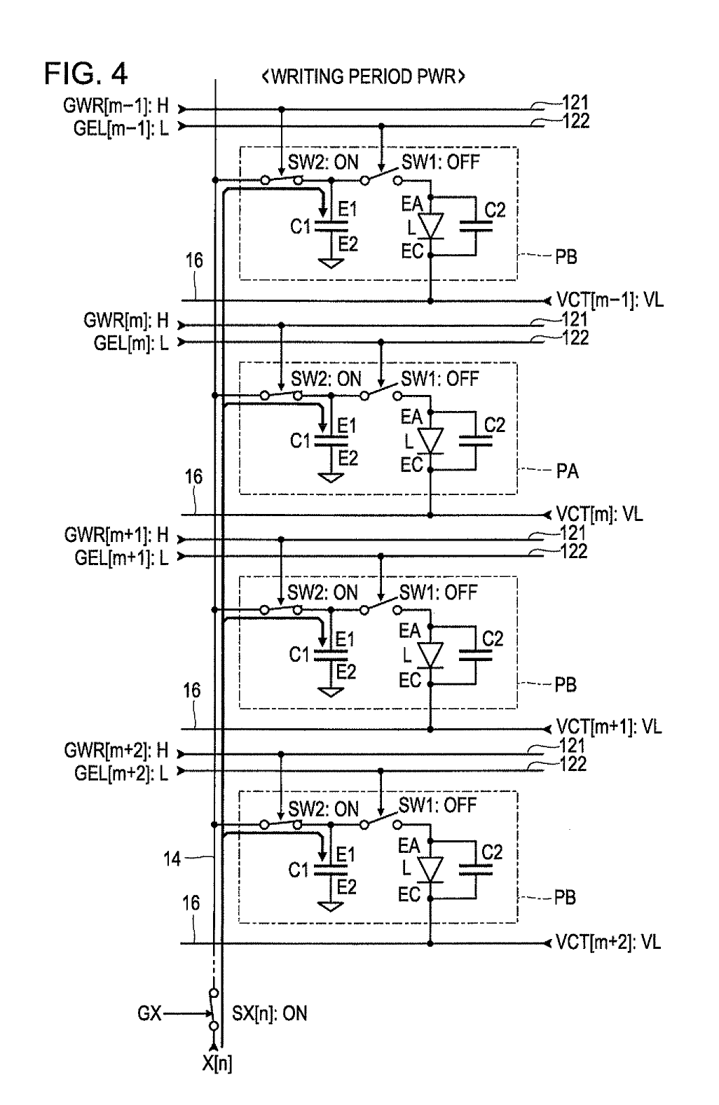

### [1] Writing Period PWR (FIG. 4)

The writing period PWR is a period in which electric charge in accordance with the gradation potential X[n] is generated and held. As illustrated in FIG. 3, in the writing period PWR, the control signal GX is set to the high level (active) to control the switches SX[1] to SX[N] of the signal line drive circuit 24 so that the switches SX[1] to SX[N] are in the ON state. Accordingly, as illustrated in FIG. 4, the gradation potential X[n] is supplied from the signal line drive circuit 24 to the signal line 14 in the nth column. The gradation potential X[n] in the horizontal scanning period H[m] is set to be variable in accordance with the specified gradation for the pixel circuit P located at the m-th row and the n-th column.

As illustrated in FIG. 3 and FIG. 4, the scanning line drive circuit 22 sets the scanning signals GWR[1] to GWR[M] to the high level (active) to control M switches SW2 in the n-th column so that the M switches SW2 are controlled to be in the ON state. That is, the capacitor electrodes E1 of M capacitors C1 are connected in parallel to the signal line 14 in the n-th column. Accordingly, electric charge in accordance with the gradation potential X[n] is held (charge) in M capacitors C1 in the n-th column.

Alternatively, the scanning line drive circuit 22 sets the control signals GEL[1] to GEL[M] to the low level (non-active) to control M switches SW1 in the n-th column so that the M switches SW1 are in the OFF state. That is, the electrodes EA of M light emitting elements L in the n-th column are isolated from the signal line 14. Accordingly, in the writing period PWR, each light emitting element L does not emit light. When the writing period PWR has passed, the control signal GX is set to the low level, so that the state of the switches SX[1] to SX[N] of the signal line drive circuit 24 is changed to the OFF state. That is, supply of the gradation potential X[n] to the signal line 14 in the n-th column is stopped.

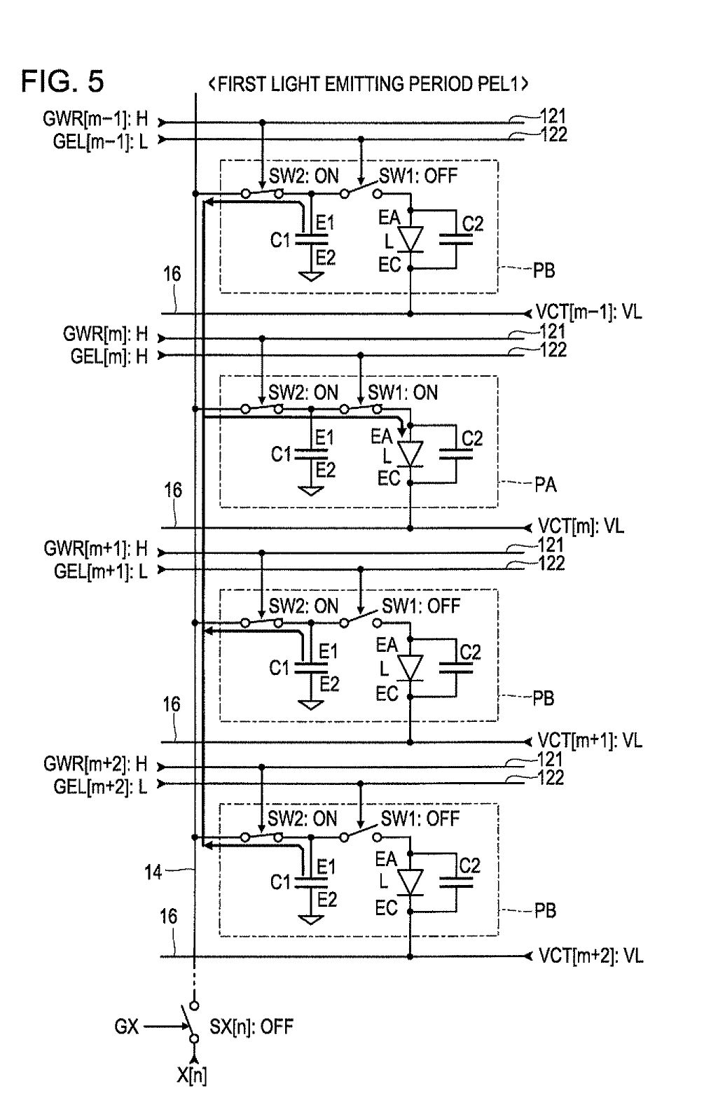

### [2] First Light Emitting Period PEL1 (FIG. 5)

The first light emitting period PEL1 after the writing period PWR is a period in which electric charge stored in M capacitors C1 in the n-th column in the writing period PWR is supplied to the light emitting element L of the target pixel circuit PA (the m-th row) in the n-th column to cause light emission. As illustrated in FIG. 3, in the first light emitting period PEL1, the scanning line drive circuit 22 sets a control signal GEL[m] to the high level to control the switch SW1 of the target pixel circuit PA so that the switch SW1 is in the ON state. The M switches SW2 in the n-th column are kept in the ON state, which is the same state as that in the writing period PWR, and therefore, as illustrated in FIG. 5, the electrode EA of the light emitting element L of the target pixel circuit PA is connected to the signal line 14 in the n-th column. Accordingly, electric charge held in the capacitors C1 of M pixel circuits P (including the target pixel circuit PA) in the n-th column in the writing period PWR is supplied (discharge) to the light emitting element L of the target pixel circuit PA. Accordingly, the light emitting element L of the target pixel circuit PA emits light with luminance in accordance with the gradation potential X[n]. Since discharging from the M capacitors C1 is completed within the first light emitting period PEL1, light emission of the light emitting element L of the target pixel circuit PA finishes within the first light emitting period PEL1.

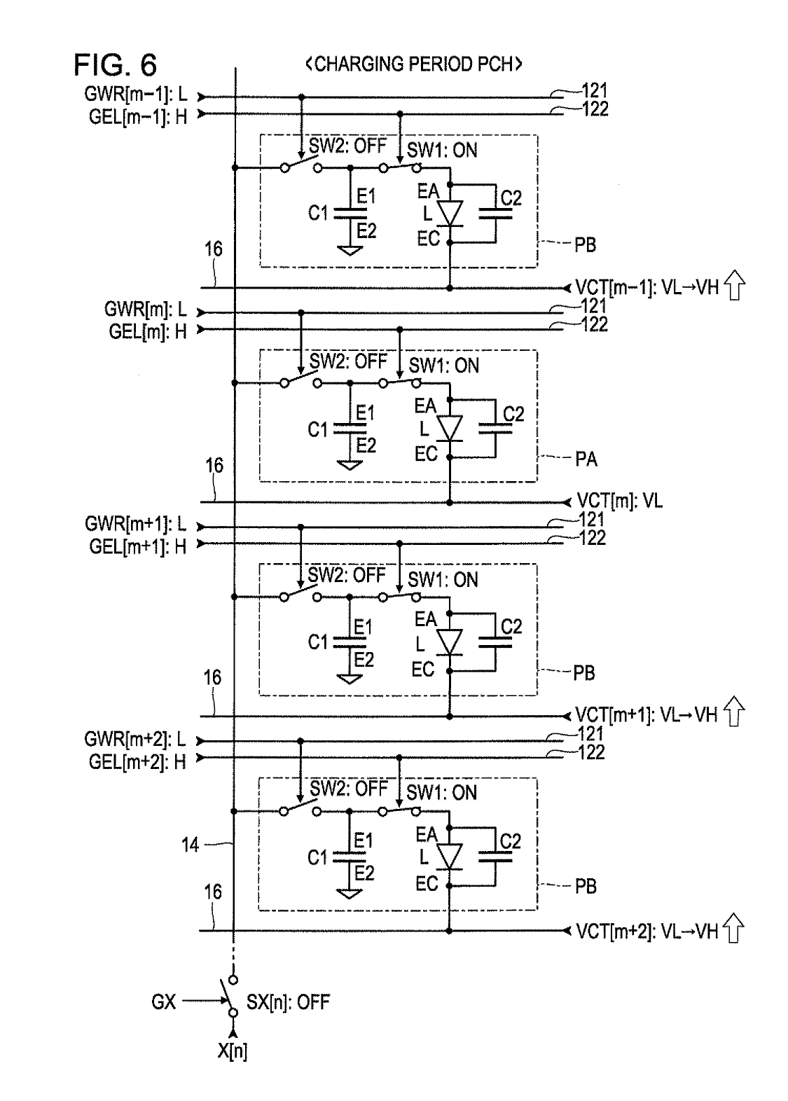

### [3] Charging Period PCH (FIG. 6)

In the writing period PWR and the first light emitting period PEL1, the potentials VCT[1] to VCT[M] of the potential lines 16 are maintained at a potential VL. The charging period PCH after the first light emitting period PEL1 is a period in which electric charge is generated and held by changing a potential. VCT[k] (k=1 to M, k≠m) supplied to each potential line 16 in (M-1) rows other than the m-th row (target pixel circuit PA) in the M rows.

As illustrated in FIG. 3, when the charging period PCH starts (time point tA1), the scanning line drive circuit 22 sets the scanning signals GWR[1] to GWR[M] to the low level to control the M switches SW2 in the n-th column so that the M switches SW2 are in the OFF state. That is, as illustrated in FIG. 6, the capacitor electrodes E1 of M capacitors C1 in the n-th column are electrically isolated from the signal line 14. As illustrated in FIG. 3, at a time point tA2 after the time point tA1, the scanning line drive circuit 22 sets the control signals GEL[1] to GEL[M] to the high level to control the M switches SW1 in the n-th column so that the M switches SW1 are in the ON state (the switch SW1 of the target pixel circuit PA is kept in the ON state, which is the same state as in the first light emitting period PEL1).

At a time point tA3 after the time point tA2, as illustrated in FIG. 3 and FIG. 6, the potential control circuit 26 changes the potential VCT[k], which is supplied to each of (M-1) pixel circuits P (hereinafter sometimes referred to as “control pixel circuits PB”) other than the target pixel circuit PA in the M pixel circuits P in the n-th column, from the potential VL to a potential VH. The potential VH is larger than the potential VL. Accordingly, when the potential VCT[k] of the potential line 16 (the electrode EC of the light emitting element L) is changed to the potential VH, a reverse bias is applied to the light emitting element L of each of the (M-1) control pixel circuits PB in the n-th column. M switches SW1 in the n-th column were controlled to be in the ON state at the time point tA2, and therefore, when each potential VCT[k] is changed to the potential VH at the time point tA3, electric charge in accordance with the potential VH (specifically, electric charge in accordance with a difference between the potential VH and the potential VL) is held in the capacitor C1 and the capacitor C2 (light emitting element L) in each of the (M-1) control pixel circuits PB.

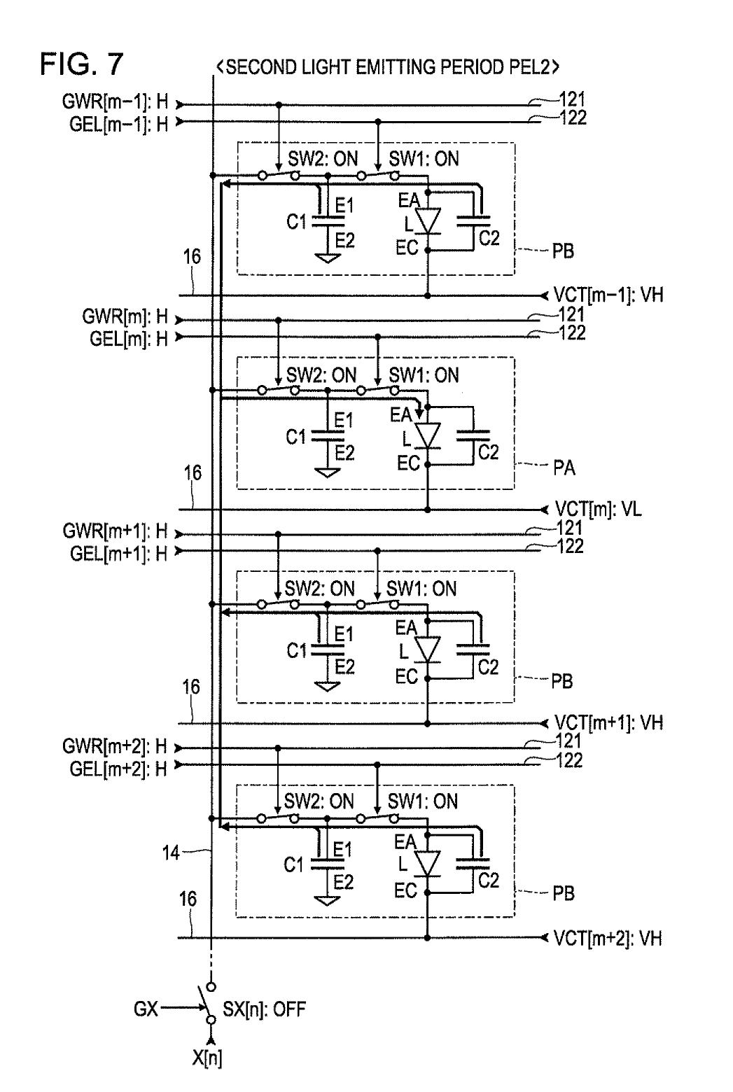

### [4] Second Light Emitting Period PEL2 (FIG. 7)

The second light emitting period PEL2 after the charging period PCH is a period in which electric charge held in the (M-1) control pixel circuits PB (C1 and C2) in the n-th column in the charging period PCH is supplied to the light emitting element L of the target pixel circuit PA (the m-th row) in the n-th column to cause light emission.

When the second light emitting period PEL2 starts, as illustrated in FIG. 3, the scanning line drive circuit 22 sets the scanning signals GWR[1] to GWR[M] to the high level to control the M switches SW2 in the n-th column so that the M switches SW2 are in the ON state. The M switches SW1 in the n-th column are kept in the ON state, which is the same state as that in the charging period PCH, and therefore, as illustrated in FIG. 7, electric charge held in the capacitor C1 and the capacitor C2 of the (M-1) control pixel circuits PB in the n-th column in the charging period PCH is supplied (discharge) to the light emitting element L of the target pixel circuit PA through the signal line 14 in the n-th column and the switch SW2 and the switch SW1 of the target pixel circuit PA. Accordingly, the light emitting element L of the target pixel circuit PA emits light with luminance in accordance with the potential VH. Since discharging from the capacitor C1 and the capacitor C2 is completed within the second light emitting period PEL2, light emission of the light emitting element L of the target pixel circuit PA finishes within the second light emitting period PEL2.

As illustrated in FIG. 3, the potential VCT[k], which is supplied to each of the (M-1) control pixel circuits PB in the n-th column, is maintained at the potential VH, which is the same as in the charging period PCH. That is, a reverse bias is applied to the light emitting element L of each control pixel circuit PB also in the second light emitting period PEL2. Accordingly, when the switch SW1 and the switch SW2 of each control pixel circuit PB are controlled to be in the ON state in the second light emitting period PEL2, the light emitting element L of each control pixel circuit PB does not emit light.

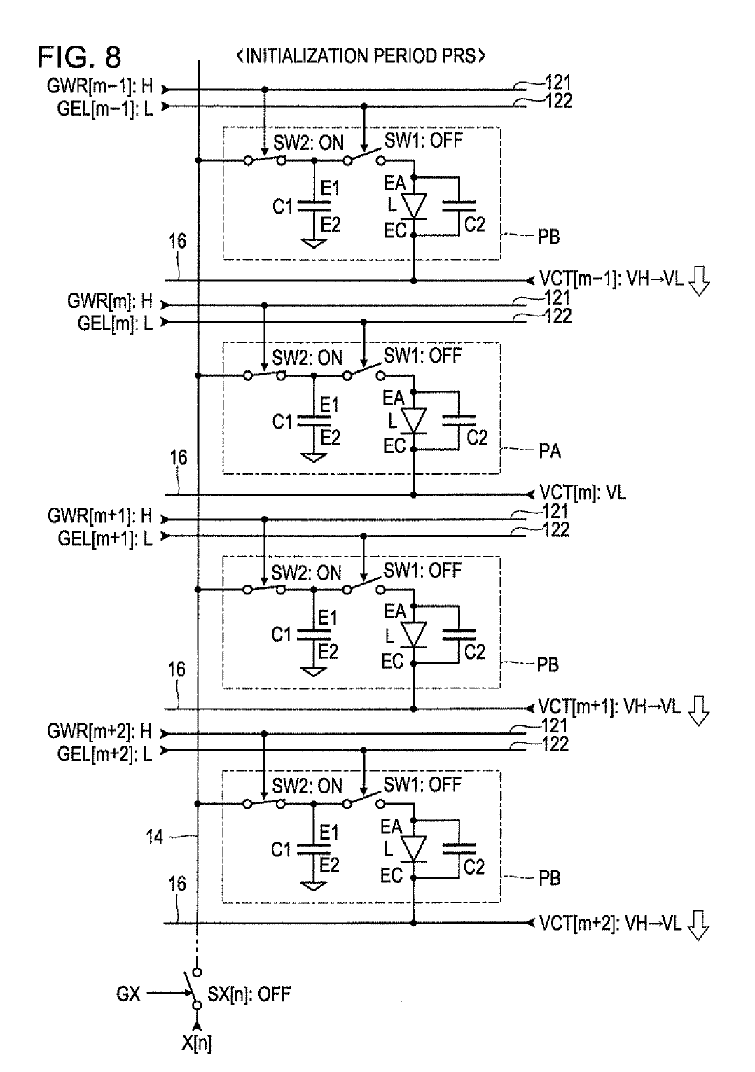

### [5] Initialization Period PRS (FIG. 8)

The initialization period PRS is a period in which the potential VCT[k] supplied to the (M-1) control pixel circuits PB is initialized to the potential VL. As illustrated in FIG. 3 and FIG. 8, when the initialization period PRS starts (time point tB1), the scanning line drive circuit 22 sets the control signals GEL[1] to GEL[M] to the low level to control the M switches SW1 in the nth column so that the M switches SW1 are in the OFF state. At a time point tB2 after the time point tB1, the potential control circuit 26 changes (initializes) the potential VCT[k] supplied to the (M-1) control pixel circuits PB, from the potential VH to the potential VL.

The above-described operation is performed in parallel in N columns in each of the horizontal scanning periods H[1] to H[M]. As illustrated in FIG. 3, the scanning signals GWR[1] to GWR[M] are set to the high level at the starting point of the second light emitting period PEL2 in the horizontal scanning period H[m], and are maintained at the high level until the end point of the first light emitting period PEL1 in a horizontal scanning period H[m+1] immediately after the horizontal scanning period H[m]. That is, the scanning signals GWR[1] to GWR[M] are fixed at the high level over the second light emitting period PEL2 and the initialization period PRS in the horizontal scanning period H[m] and the writing period PWR and the first light emitting period PEL1 in the horizontal scanning period H[m+1].

As described above, in the first light emitting period PEL1, electric charge stored in M capacitors C1 is supplied to the light emitting element L of one target pixel circuit PA. Accordingly, compared to the technique of JP-A-2006-3716 in which only electric charge of one capacitor in the pixel circuit P is supplied to the light emitting element L of the pixel circuit P, there is an advantage that the luminance of the light emitting element L can be sufficiently secured even in the case of reducing the capacitance of the capacitor C1 to downsize the pixel circuit P, that is, compatibility between the securing of the luminance and the downsizing of the pixel circuit P.

Electric charge is held in the capacitor C1 and the capacitor C2 of each of the (M-1) control pixel circuits PB in the charging period PCH, and is supplied to the light emitting element L of the target pixel circuit PA in the second light emitting period PEL2. Accordingly, compared to a configuration in which the operation in the second light emitting period PEL2 is not performed, it is possible to secure sufficient luminance for the light emitting element L. In other words, since the capacitance of the capacitor C1 required for securing the luminance of the light emitting element L is reduced, there is an advantage that downsizing of the capacitor C1 (resulting in downsizing of the pixel circuit P) can be achieved. That is, an advantageous effect in that the securing of the luminance of the light emitting element L is compatible with the downsizing of the pixel circuit P is particularly marked compared to the configuration in which the operation in the second light emitting period PEL2 is not performed.

According to the first embodiment, effects to be described below are further obtained. In the following, modifications of the first embodiment are exemplified, and advantageous effects of the first embodiment are described. It should be noted that, although the first embodiment is advantageous compared to each modification, it is not intended to exclude modifications from the scope of the invention. The following modifications may be applied to a second embodiment and the subsequent embodiments in the same way as to the first embodiment.

(A) In the first embodiment, as illustrated in FIG. 6, the switch SW1 of each control pixel circuit PB is controlled to be in the ON state, in the charging period PCH. However, a configuration in which the switch SW1 of each control pixel circuit PB is kept in the OFF state in the charging period PCH (hereinafter referred to as “modification A”) may be employed.

In modification A, however, electric charge generated by the change of the potential VCT[k] in the charging period PCH is held only in the capacitor C2 of each control pixel circuit PB, and therefore there is a possibility of causing a shortage in the amount of electric charge supplied to the light emitting element L (luminance of the light emitting element L) of the target pixel circuit PA in the second light emitting period PEL2. On the other hand, in the first embodiment, the switch SW1 of each control pixel circuit PB is controlled to be in the ON state, in the charging period PCH, and therefore electric charge generated by the change of the potential VCT[k] is held in both the capacitor C2 and the capacitor C1 of each control pixel circuit PB. Accordingly, there is an advantage that the luminance of the light emitting element L (the amount of electric charge supplied to the light emitting element L) of the target pixel circuit PA in the second light emitting period PEL2 is sufficiently secured compared to modification A.

(B) In the first embodiment, as illustrated in FIG. 3, the M switches SW2 in the n-th column are controlled to be in the OFF state at the time point tA1 (starting point) of the charging period PCH, and the M switches SW1 are controlled to be in the ON state at the time point tA2 after the time point tA1. However, a configuration in which each switch SW1 is controlled to be in the ON state and then each switch SW2 is controlled to be in the OFF state (hereinafter referred to as “modification B”) may be employed.

However, in modification B, the switches SW1 are changed to the ON state under the condition that the switches SW2 are kept in the ON state. Therefore, there is a possibility that noise caused by the operation of the switch SW1 in each control pixel circuit PB (e.g., noise caused by a feedthrough of the switch SW1) is supplied through the switch SW2 of each control pixel circuit PB and the switch SW2 and the switch SW1 of the target pixel circuit PA to the light emitting element L of the target pixel circuit PA, resulting in light emission of the light emitting element L. On the other hand, in the first embodiment, each switch SW1 is changed to the ON state in the stage where each switch SW2 has been changed to the OFF state. Therefore, noise caused by the operation of the switch SW1 is blocked by the switch SW2 in the OFF state. Accordingly, there is an advantage that erroneous light emission of the light emitting element L of the target pixel circuit PA (further, contrast reduction resulting from the erroneous light emission of the light emitting element L) is suppressed compared to modification B.

(C) In the first embodiment, as illustrated in FIG. 3, at the time point tB1 (starting point) of the initialization period PRS, the M switches SW1 in the n-th column are controlled to be in the OFF state, and, at the time point tB2 after the time point tB1, the potential VCT[k] of each control pixel circuit PB is changed from the potential VH to the potential VL. However, a configuration in which the order between the operation of the switch SW1 and the change of the potential VCT[k] is reversed (hereinafter referred to as “modification C”) may also be employed.

In modification C, however, at the time point of the change of the potential VCT[k] from the potential VH to the potential VL (i.e., the time point when the light emitting element L of the control pixel circuit PB enters a state where the light emitting element L can emit light), both the switch SW1 and the switch SW2 are kept in the ON state, and therefore noise generated, for example, in the signal line 14 can be supplied through the switch SW2 and the switch SW1 to the light emitting element L of the control pixel circuits PB to cause erroneous light emission of the light emitting element L. On the other hand, in the first embodiment, after the transition of each switch SW1 from the ON state to the OFF state (i.e., after the light emitting element L is insulated from the signal line 14), the potential VCT[k] decreases to the potential VL. That is, in the state where the potential VCT[k] is set to the potential VL, noise generated in the signal line 14 is blocked by the switch SW1 in the OFF state. Accordingly, there is an advantage that erroneous light emission of the light emitting element L of each control pixel circuit PB (further, contrast reduction resulting from erroneous light emission of the light emitting element L) is suppressed compared to modification C.

(D) In the first embodiment, the levels of the scanning signals GWR[1] to GWR[M] are fixed from the starting point of the second light emitting period PEL2 of the horizontal scanning period H[m] to the end point of the first light emitting period PELT of the horizontal scanning period H[m+1] immediately after the horizontal scanning period H[m]. However, a configuration in which the levels of the scanning signals GWR[1] to GWR[M] are appropriately changed (hereinafter referred to as “modification C”) may also be employed. For example, if, in the initialization period PRS, the scanning signals GWR[1] to GWR[M] are set to the low level so that the M switches SW2 in the nth column are controlled to be in the OFF state, noise generated in the signal line 14 is blocked by the switches SW2, and therefore there is an advantage that erroneous light emission of the control pixel circuits PB which is a problem in modification C can be prevented with high accuracy. On the other hand, in the first embodiment, the number of times the levels of the scanning signals GWR[1] to GWR[M] are changed (the number of times charging and discharging the capacitors associated with the scanning lines 121 is performed) is decreased compared to modification D, and therefore there is an advantage that power consumption of the scanning line drive circuit 22 is reduced.

### B: Second Embodiment

Next, the second embodiment of the invention is described. Note that elements whose actions and functions in the following embodiments are equivalent to those in the first embodiment are denoted by the same reference characters, and detailed description of each of the elements is omitted as appropriate.

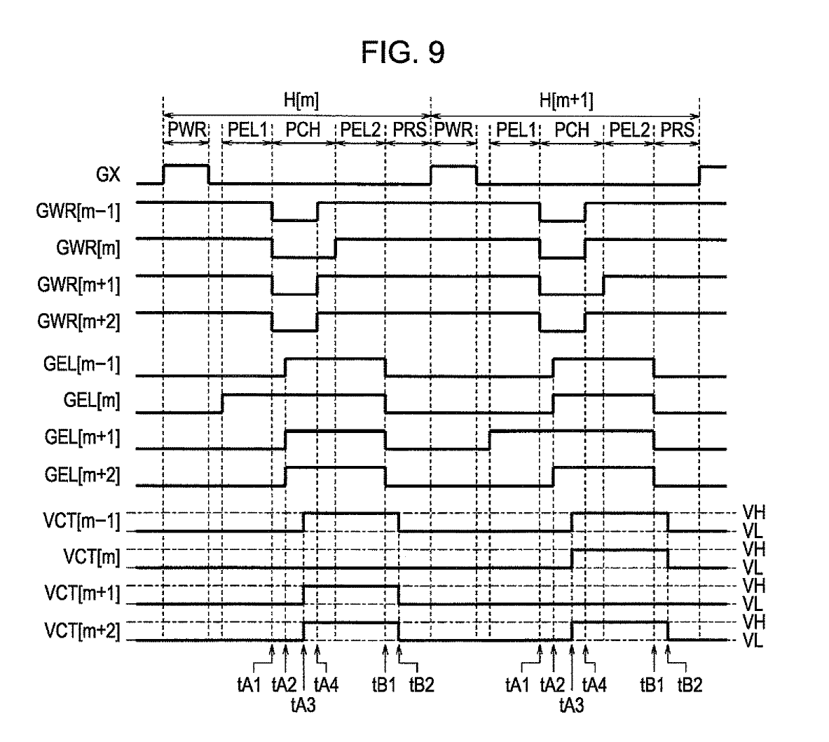

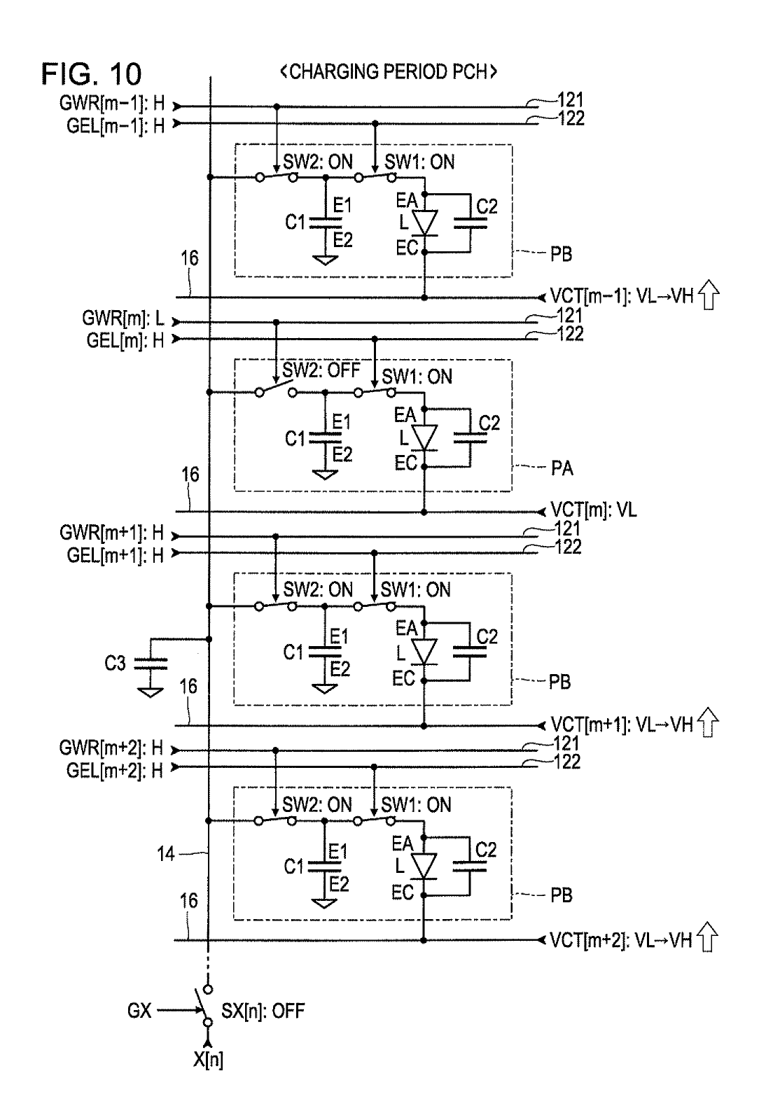

FIG. 9 is a timing chart of the operation of the light emitting device 100 in the second embodiment, and FIG. 10 is a conceptual diagram illustrating a state of each pixel circuit P in the n-th column in the charging period PCH. As illustrated in FIG. 10, a capacitor (parasitic capacitance) C3 is associated with each signal line 14.

As illustrated in FIG. 9, at a time point tA4 after the time point tA3 (a time point at which the potential VCT[k] is changed to the potential VH) in the charging period PCH, the scanning line drive circuit 22 sets a scanning signal GWR[k] in each of (M-1) rows other than the m-th row (target pixel circuit PA) to the high level. Accordingly, as illustrated in FIG. 10, the switch SW2 of each control pixel circuit PB changes to the ON state to cause the electrode EA of the light emitting element L in each control pixel circuit PB to be connected to the signal line 14 in the n-th column. Under these conditions, electric charge in accordance with the potential VH is held (charge) in the capacitor C3 of the signal line 14 in addition to the capacitor C1 and the capacitor C2 of each control pixel circuit PB.

When, with the start of the second light emitting period PEL2, the state of the switch SW2 of the target pixel circuit PA is changed to the ON state, electric charge held in the capacitors C1 and the capacitors C2 of (M-1) control pixel circuits PB in the n-th column and in the capacitor C3 of the signal line 14 in the n-th column is supplied to the light emitting element L of the target pixel circuit PA in the n-th column.

Advantageous effects similar to those in the first embodiment are achieved in the second embodiment. Further, in the second embodiment, electric charge supplied to the light emitting element L of the target pixel circuit PA in the second light emitting period PEL2 is held in the capacitor C3 of the signal line 14 as well as in the capacitor C1 and the capacitor C2 of each control pixel circuit PB. The second embodiment therefore has an advantage that the luminance of the light emitting element L (the amount of electric charge supplied to the light emitting element L) of the target pixel circuit PA in the second light emitting period PEL2 is sufficiently secured compared to the first embodiment.

### C: Third Embodiment

In the embodiments described above, the potential VH (VCT[k]) of the potential line 16 after the change in the charging period PCH is fixed at a given value. In the third embodiment, the potential VH in the charging period PCH is set to be variable. This adjusts the overall lightness (controls lighting) of the element section 10.

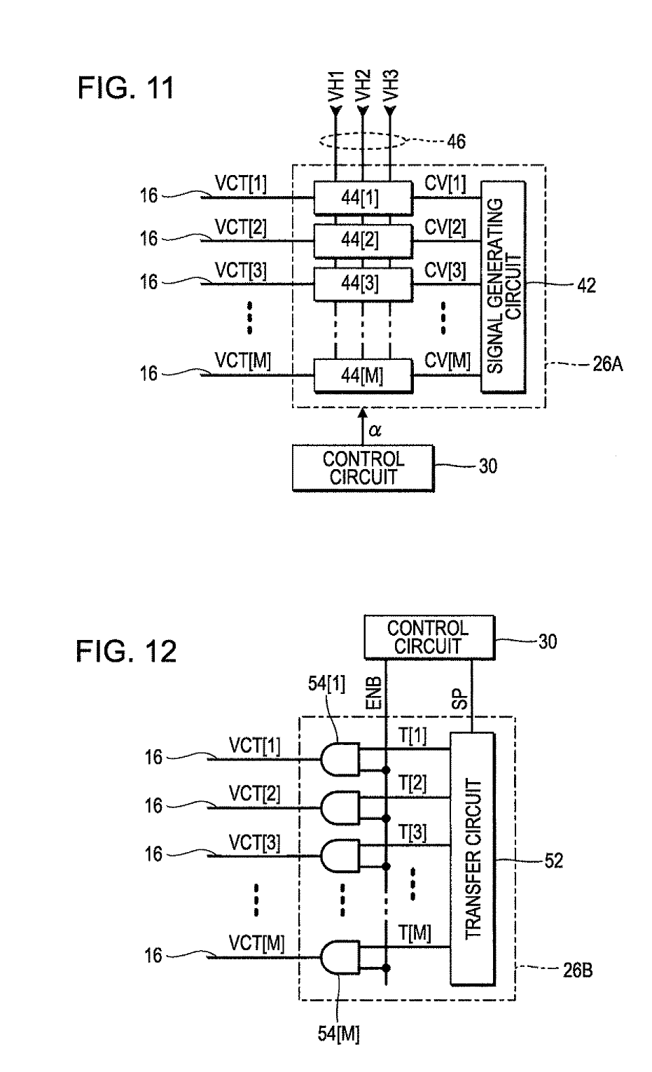

In the configuration of the third embodiment, the potential control circuit 26 in the light emitting device 100 of the first embodiment is replaced with a potential control circuit 26A illustrated in FIG. 11. As illustrated in FIG. 11, the potential control circuit 26A is configured to include the signal generating circuit 42 and M selection circuits 44[1] to 44[M]. The signal generating circuit 42 generates and outputs control signals CV[1] to CV[M]. A control signal CV[m] is a signal specifying either the potential VL or the potential VH for a potential VCT[m] supplied to potential line 16 in the m-th row. The waveform of the potential VCT[m] in the third embodiment is similar to that of the potential VCT[m] in the first embodiment. Accordingly, as will be understood from FIG. 3, the control signal CV[m] specifies the potential VH for a period from the time point tA3 in the charging period PCH to the time point tB2 in the initialization period PRS, and specifies the potential VL for all other periods.

A selection circuit 44[m] illustrated in FIG. 11 generates the potential VCT[m] from the control signal CV[m] and outputs the potential VCT[m] to the potential line 16 in the m-th row. A plurality of (three types in this embodiment) potentials VH1 to VH3 which are different from one another are commonly output through individual feeders 46 to the selection circuits 44[1] to 44[M]. In a period for which the control signal CV[m] specifies the potential VL, the selection circuit 44[m] outputs the potential VL as the potential VCT[m] to the potential line 16 in the m-th row. In a period for which the control signal CV[m] specifies the potential VH, any one of the plurality of potentials VH1 to VH3 is selected in accordance with an indicated value α, and then is output as the potential VCT[m] to the potential line 16 in the m-th row. That is, the potential VH of the potential VCT[m] is set to be variable in accordance with the indicated value α. The indicated value α is specified from the control circuit 30 according to a user's operation by using an operation unit (not illustrated).

Like the first embodiment, electric charge held in the capacitor C1 and the capacitor C2 of each control pixel circuit PB in accordance with the potential VH of the potential line 16 in the charging period PCH is supplied to the light emitting element L of the target pixel circuit PA in the second light emitting period PEL2. That is, the luminance of the light emitting element L of each target pixel circuit PA in the second light emitting period PEL2 is controlled to be variable in accordance with the potential VH (i.e., in accordance with the indicated value α) which selection circuit 44[m] of the potential control circuit 26A has selected from the plurality of potentials VH1 to VH3. Accordingly, advantageous effects similar to those in the first embodiment are achieved in the third embodiment. Further, the third embodiment has an advantage that the overall lightness of the element section 10 can appropriately be adjusted. Specifically, the higher the potential VH selected by the selection circuit 44 is, the more the whole lightness of the element section 10 increases. Note that the configuration of the second embodiment in which electric charge is held in the capacitor C3 of the signal line 14 in the charging period PCH is applied also to the third embodiment.

### D: Fourth Embodiment

In the embodiments described above, the potentials VCT[k] of (M-1) potential lines 16 in rows other than the m-th row (target pixel circuit PA) are changed to the potential VH in the charging period PCH. In the fourth embodiment, the total number of potentials VCT[k] to be changed to the potential VH in the charging period PCH (the total number of the control pixel circuits PB in the n-th column) is controlled to be variable. This adjusts the overall lightness (controls the lighting) of the element section 10.

The fourth embodiment has a configuration in which the potential control circuit 26 in the first embodiment is replaced with a potential control circuit 26B illustrated in FIG. 12. As illustrated in FIG. 12, the potential control circuit 26B is configured to include a transfer circuit 52 and M logic circuits 54[1] to 54[M].

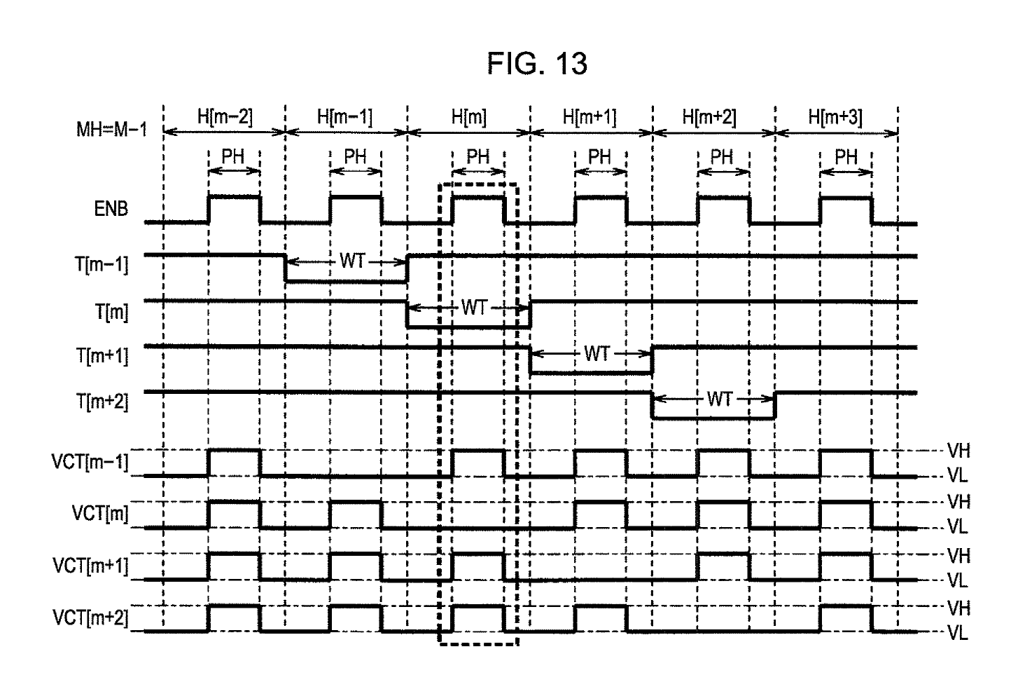

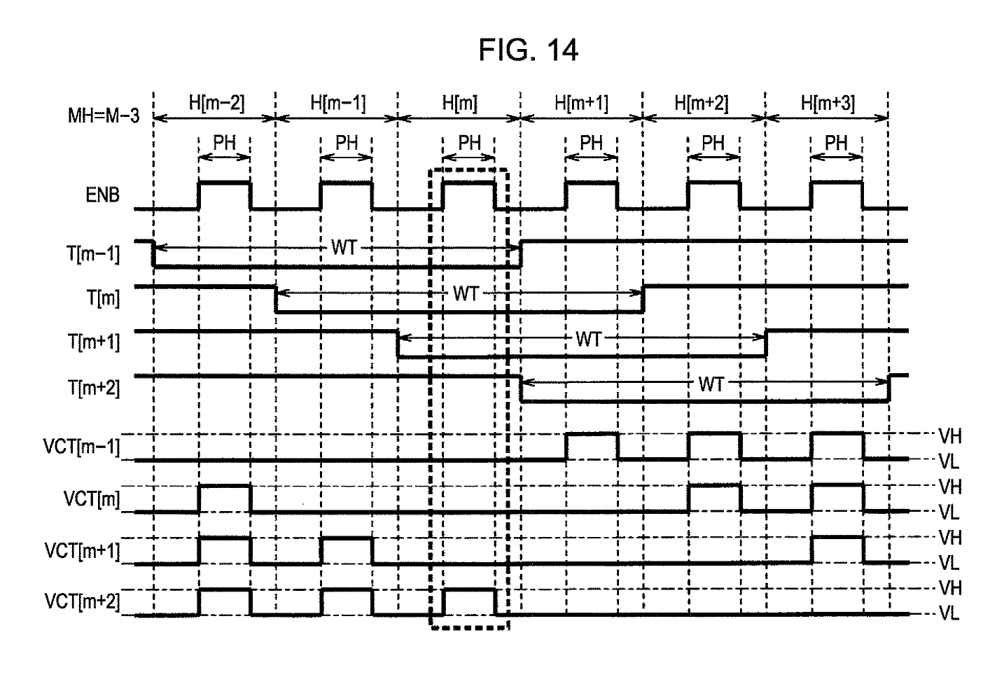

The transfer circuit 52 is a shift register which sequentially delays start pulses SP supplied from the control circuit 30 to generate transfer signals T[1] to T[M]. As illustrated in FIGS. 13 and 14, each transfer signal T[m] is a signal obtained by delaying a transfer signal T[m−1] at the previous stage (the start pulse SP in the case of the transfer signal T[1]) by a time corresponding to one horizontal scanning period H[m]. A pulse width (time length during which the signal is maintained at the low level) WT of each of the transfer signals T[1] to T[M] is set in accordance with the width of the start pulse SP. Accordingly, the total number MH of the transfer signals T which are simultaneously set to the low level within the horizontal scanning period H[m] varies in accordance with the width of the start pulse SP.

For example, as illustrated in FIG. 13, in cases where the start pulse SP is set such that the pulse width WT corresponds to one horizontal scanning period H[m], only the transfer signal T[m] among the transfer signals T[1] to T[M] is set to the low level (MH=1) in the horizontal scanning period H[m]. On the other hand, as illustrated in FIG. 14, in cases where the start pulse SP is set such that the pulse width WT corresponds to three horizontal scanning periods H[m], transfer signals T[m−1] to T[m+1] of three systems are set to the low level (MH=3) in the horizontal scanning period H[m].

Supplied to the M logic circuits 54[1] to 54[M] illustrated in FIG. 12 is a control signal ENB, which is common to the M logic circuits 54[1] to 54[M], from the control circuit 30. As illustrated in FIGS. 13 and 14, the control signal ENB is set to the high level in a period PH in each of the horizontal scanning periods H[1] to H[M], and is set to the low level in all periods other than the period PH. The period PH is a period during which any one of the potentials VCT[1] to VCT[M] is set to the potential VH (specifically, a period from the time point tA3 in the charging period PCH to the time point tB2 in the initialization period PRS).

Each logic circuit 54[m] is an AND circuit which outputs an AND of the transfer signal T[m] output from the transfer circuit 52 and the control signal ENB supplied from the control circuit 30, as the potential VCT[m], to the potential line 16 in the m-th row. That is, in cases where the transfer signal T[m] is at the high level in the horizontal scanning period H, the potential VCT[m] is set to the potential VH in the period PH, and is set to the potential VL in all periods other than the period PH. On the other hand, from the starting point to the end point in the horizontal scanning period H in which the transfer signal T[m] is set to the low level, the potential VCT[m] is maintained at the potential VL.

For example, as illustrated in a broken line of FIG. 13, in the period PH of the horizontal scanning period H[m] in which only the transfer signal T[m] in the m-th row (target pixel circuit PA) is at the low level, the potentials VCT[k] of (M-1) systems, which are obtained by excluding the potential VCT[m] from the potentials VCT[1] to VCT[M], are set to the potential VH (MH=M-1), like the first embodiment (FIG. 6). Accordingly, in the charging period PCH in the horizontal scanning period H[m], electric charge in accordance with the potential VH is held in the capacitor C1 and the capacitor C2 in the (M-1) control pixel circuits PB other than the control pixel circuit PB in the m-th row among the control pixel circuits PB in the n-th column.

On the other hand, as illustrated in a broken line in FIG. 14, in the period PH of the horizontal scanning period H[m] in which the transfer signals T[m−1] to T[m+1] are at the low level, the potentials VCT[k] of (M-3) systems, which are obtained by excluding potentials VCT[m−1] to VCT[m+1] from the potentials VCT[1] to VCT[M], are set to the potential VH (MH=M-3). That is, in the charging period PCH of the horizontal scanning period H[m], electric charge in accordance with the potential VH is held in the capacitors C1 and the capacitors C2 of the (M-3) control pixel circuits PB other than the control pixel circuits PB in three rows from the (m−1)-th row to the (m+1)-th row among the control pixel circuits PB in the nth column.

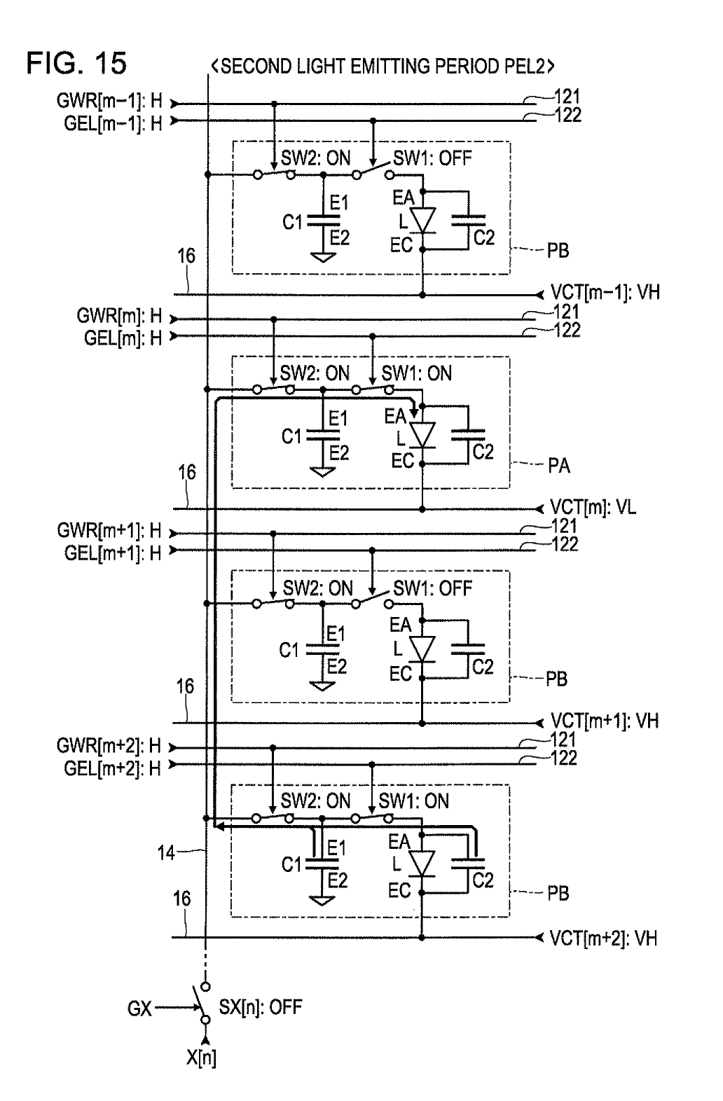

As illustrated, for example, in FIG. 15 (in the case of MH=M-3), the scanning line drive circuit 22 controls the switch SW1 of the target pixel circuit PA and the switches SW1 of MH control pixel circuits PB (the control pixel circuit PB in the (m+2)-th row in FIG. 15) are controlled to be in the ON state, in the second light emitting period PEL2. Accordingly, in the second light emitting period PEL2, electric charge is supplied to the target pixel circuit PA from MH control pixel circuits PB, where MH is a variable number.

For example, in the case illustrated in FIG. 13, in the second light emitting period PEL2 of the horizontal scanning period H[m], electric charge is supplied from the capacitors C1 and the capacitors C2 of (M-1) (MH) control pixel circuits PB to the target pixel circuit PA, so that the light emitting element L emits light, just as in the first embodiment. On the other hand, in the case illustrated in FIG. 14, in the charging period PCH of the horizontal scanning period H[m], electric charge is supplied to the target pixel circuit PA from the capacitors C1 and the capacitors C2 of (M-3) control pixel circuits PB other than the control pixel circuits PB in three rows from the (m−1)-th row to the (m+1)-th row among the control pixel circuits PB in the n-th column, so that the light emitting element L emits light.

The luminance of the light emitting element L of the target pixel circuit PA in the second light emitting period PEL2 varies in accordance with the number MH (the amount of electric charge) of the control pixel circuits PB functioning as the source of supplying electric charge. For example, the luminance of the light emitting element L of the target pixel circuit PA in the second light emitting period PEL2 in the case of FIG. 13 is higher than that in the case of FIG. 14. Therefore, according to the fourth embodiment, advantageous effects similar to those in the first embodiment are achieved. Further, the fourth embodiment has an advantage that the overall lightness of the element section 10 can be controlled in accordance with the number MH of the control pixel circuits PB.

Since the number MH of the control pixel circuits PB is adjusted in accordance with the width of the start pulse SP, this embodiment has another advantage that the configuration of the potential control circuit 26 is simplified. For example, in the third embodiment, the feeders 46 the number of which is in accordance with the number of stages of lighting control (potentials VH the number of which is in accordance with the number of stages) are required. ON the other hand, in the fourth embodiment, the degree of lighting control varies in accordance with the width of the start pulse SP. This can increase the number of stages of lighting control without causing the configuration of the potential control circuit 26 to grow complicated (i.e., increasing the number of lines just as in the third embodiment).

Note that a configuration obtained by combining the third embodiment and the fourth embodiment may be employed. Specifically, the selection circuits 44[1] to 44[M] of the third embodiment are disposed at the stage subsequent to that of the logic circuits 54[1] to 54[M] illustrated in FIG. 12, and the selection circuit 44[m] selects the potential VH of the potential VCT[m] from a plurality of potentials VH1 to VH3 in accordance with an output signal of the logic circuit 54[m]. The described configuration can further increase the number of stages of lighting control.

### E: Fifth Embodiment

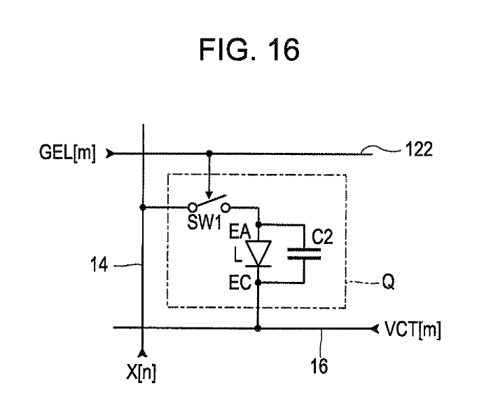

The fifth embodiment has a configuration in which the pixel circuit P in the first embodiment is replaced with a pixel circuit Q illustrated in FIG. 16. As illustrated in FIG. 16, the pixel circuit Q is configured to include the light emitting element L with which the capacitor C2 is associated, and the switch SW1 which is disposed between the electrode EA of the light emitting element L and the signal line 14. A gate of the switch SW1 is connected to the control line 122. That is, the pixel circuit Q has a configuration in which the switch SW2 (scanning line 121) and the capacitor C1 are removed from the pixel circuit P in the first embodiment. The operation of the fifth embodiment is described below, with attention paid to each pixel circuit Q in the n-th column in the horizontal scanning period H[m].

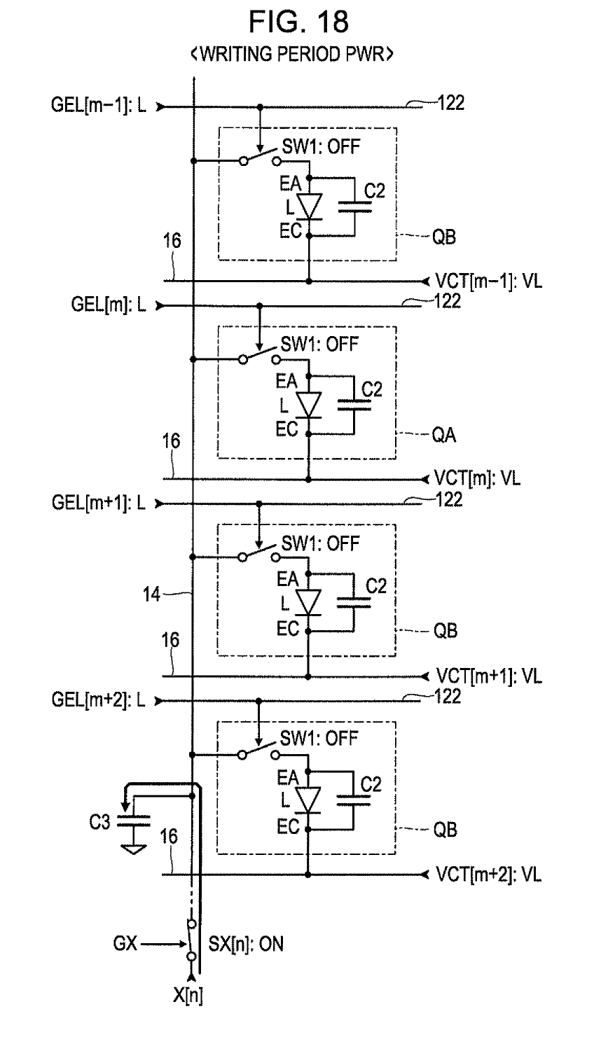

### [1] Writing Period PWR (FIG. 18)

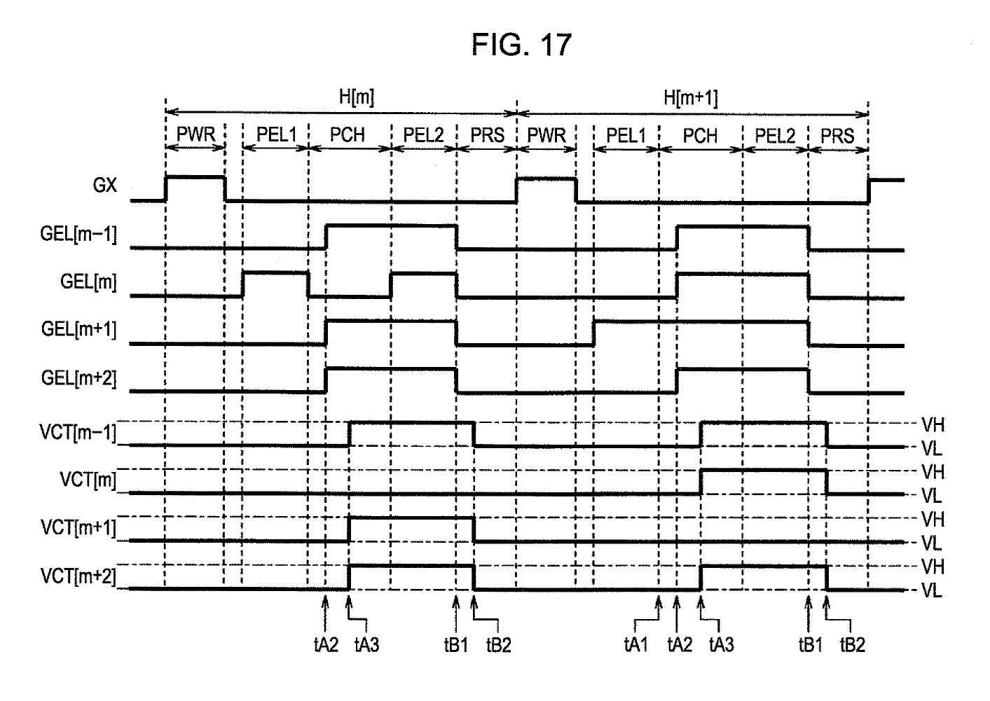

As illustrated in FIG. 17 and FIG. 18, the scanning line drive circuit 22 sets the control signals GEL[1] to GEL[M] to the low level in the writing period PWR to control M switches SW1 in the n-th column so that the M switches SW1 are in the OFF state. On the other hand, the control signal GX is set to the high level, thereby supplying the gradation potential X[n] to the signal line 14 in the nth column. Accordingly, as illustrated in FIG. 18, electric charge in accordance with the gradation potential X[n] is held (charge) in the capacitor C3 of the signal line 14 in the n-th column.

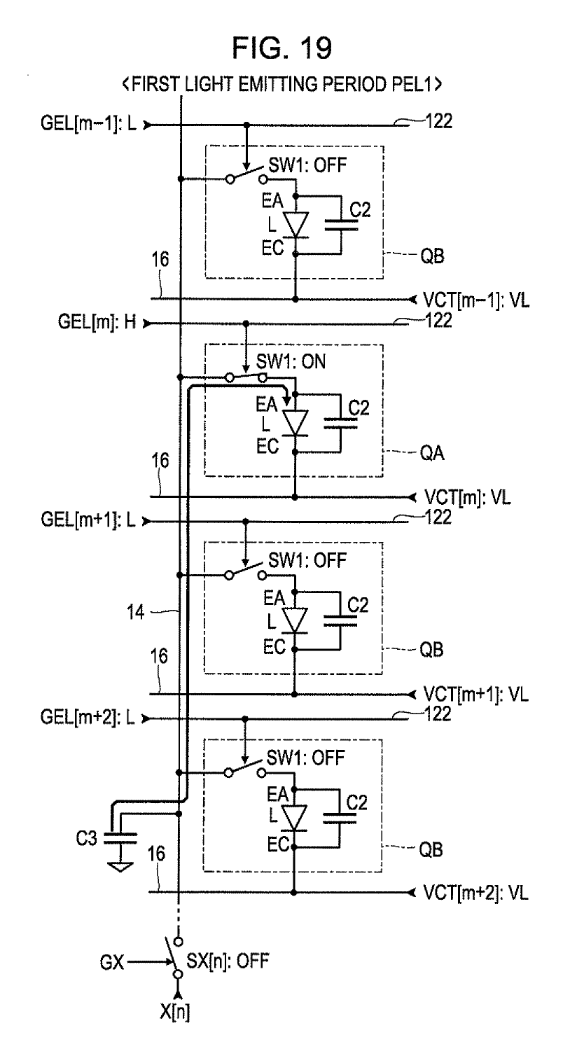

### [2] First Light Emitting Period PEL1 (FIG. 19)

In the first light emitting period PEL1, as illustrated in FIG. 17, the scanning line drive circuit 22 sets the control signal GEL[m] to the high level to control the switch SW1 of the target pixel circuit QA so that the switch SW1 is in the ON state. Accordingly, as illustrated in FIG. 19, electric charge held in the capacitor C3 of the signal line 14 in the writing period PWR is supplied through the switch SW1 of the target pixel circuit QA to the light emitting element L. Accordingly, the light emitting element L of the target pixel circuit QA emits light with luminance in accordance with the gradation potential X[n]. At the end point of the first light emitting period PEL1 (the starting point in the charging period PCH), the control signal GEL[m] is set to the low level to cause the state of the switch SW1 of the target pixel circuit QA to be changed to the OFF state.

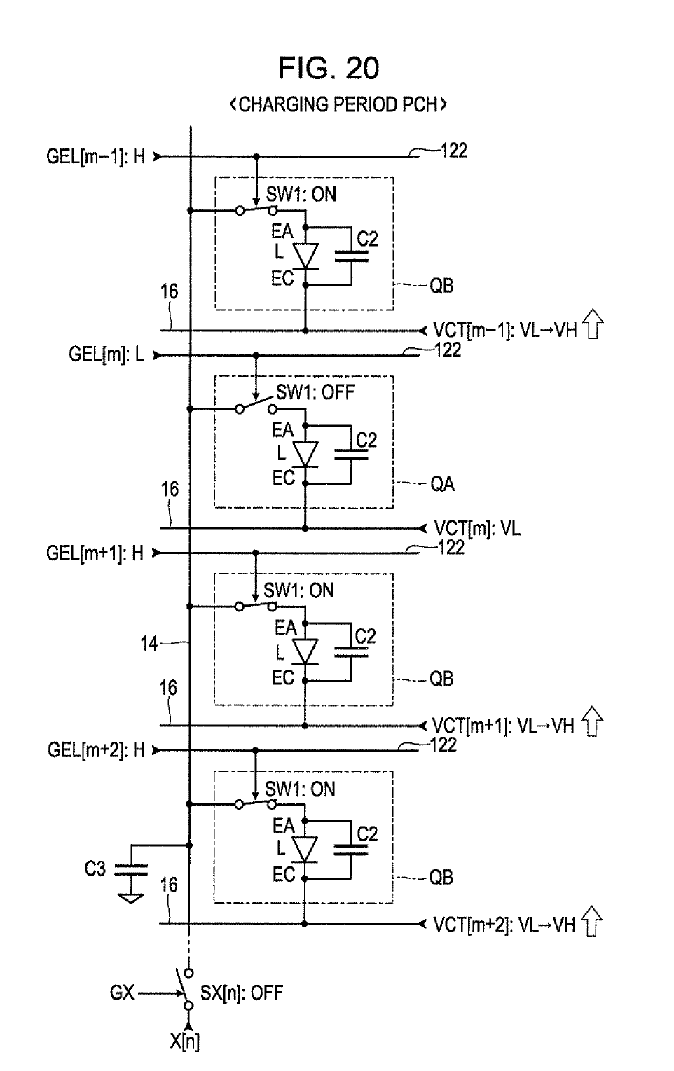

### [3] Charging Period PCH (FIG. 20)

As illustrated in FIG. 17 and FIG. 20, at the time point tA2 after the start of the charging period PCH, the scanning line drive circuit 22 sets the control signals GEL[m] in (M-1) rows other than the m-th row (target pixel circuit QA) to the high level to control the switch SW1 of each control pixel circuit QB so that the switch SW1 is in the ON state. At the time point tA3 after the time point tA2, the potential control circuit 26 changes the potential VCT[k], which is to be supplied to each of (M-1) control pixel circuits QB, from the potential VL to the potential VH. Accordingly, as will be understood from FIG. 20, electric charge in accordance with the potential VH is held in the capacitor C2 in each of the (M-1) control pixel circuits QB and the capacitor C3 of the signal line 14 in the n-th column.

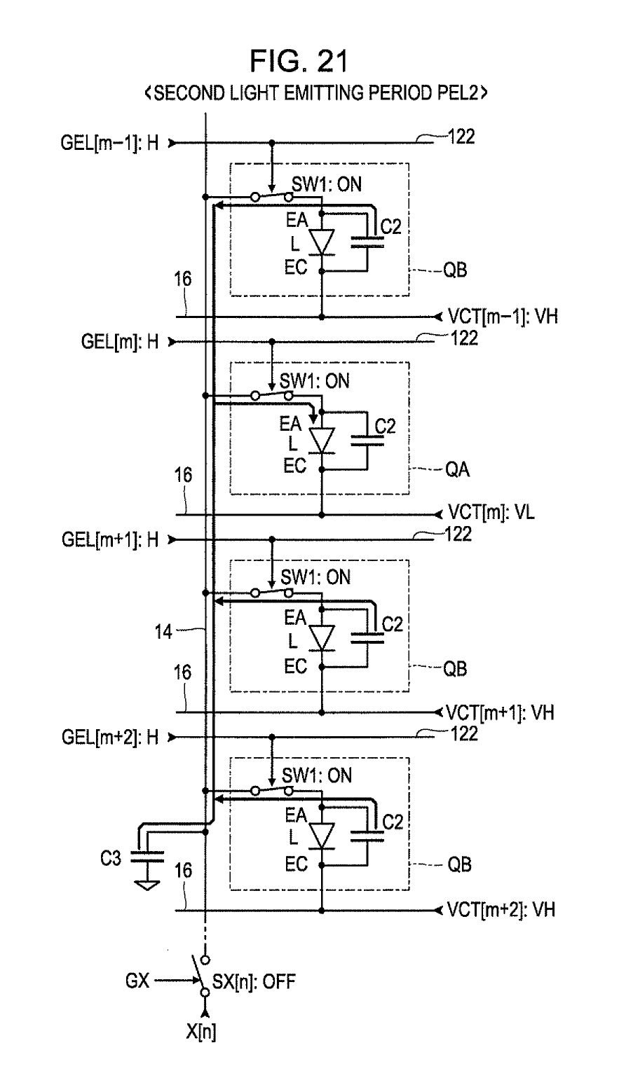

### [4] Second Light Emitting Period PEL2 (FIG. 21)

In the second light emitting period PEL2, as illustrated in FIG. 17, the scanning line drive circuit 22 sets the control signals GEL[1] to GEL[M] to the high level to control M switches SW1 in the n-th column so that the M switches SW1 are in the ON state. Accordingly, as illustrated in FIG. 21, electric charge held in (M-1) capacitors C2 and the capacitor C3 of the signal line 14 is supplied to the light emitting element L of the target pixel circuit QA in the m-th row in the charging period PCH. Accordingly, the light emitting element L of the target pixel circuit QA emits light with luminance in accordance with the potential VH.

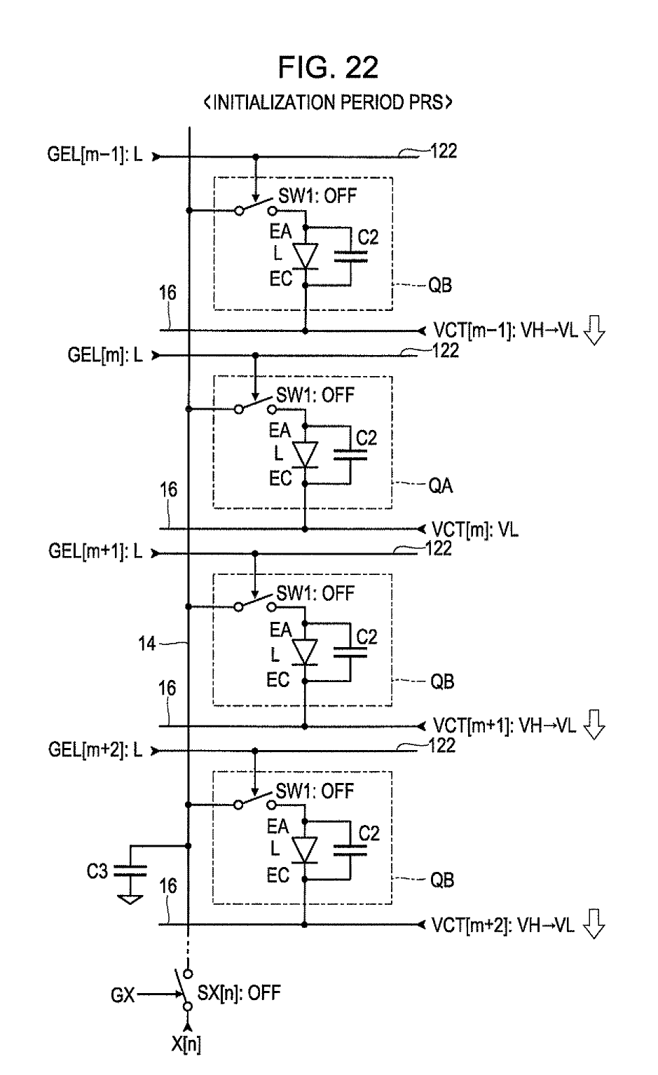

### [5] Initialization Period PRS (FIG. 22)

As illustrated in FIG. 17 and FIG. 22, at the time point tB1 at which the initialization period PRS starts, the scanning line drive circuit 22 sets the control signals GEL[1] to GEL[M] to the low level to control M switches SW1 in the n-th column so that the M switches SW1 are in the OFF state. Then, at the time point tB2 after the time point tB1, the potential control circuit 26 initializes the potential VCT[k], which is to be supplied to the (M-1) control pixel circuits QB, from the potential VH to the potential VL.

As will be understood from the foregoing description, advantageous effects similar to those in the first embodiment are achieved in the fifth embodiment. Since the pixel circuit Q of the fifth embodiment does not require the capacitor C1 and the switch SW2 in the first embodiment, there is an advantage that the configuration of the element section 10 is simplified. Accordingly, the fifth embodiment is particularly preferable in cases where the pixel circuit Q needs to be finer. Note that the configuration of the third embodiment in which the potential VH of the potential VCT[m] is set to be variable and the configuration of the fourth embodiment in which the total number MH of the control pixel circuits QB is controlled to be variable are applied in the same manner to the fifth embodiment.

### F: Modifications

Various modifications are added to each of the foregoing embodiments. Specific examples of modifications are mentioned below. Two or more examples selected from the examples mentioned below may be combined.

### (1) Modification 1

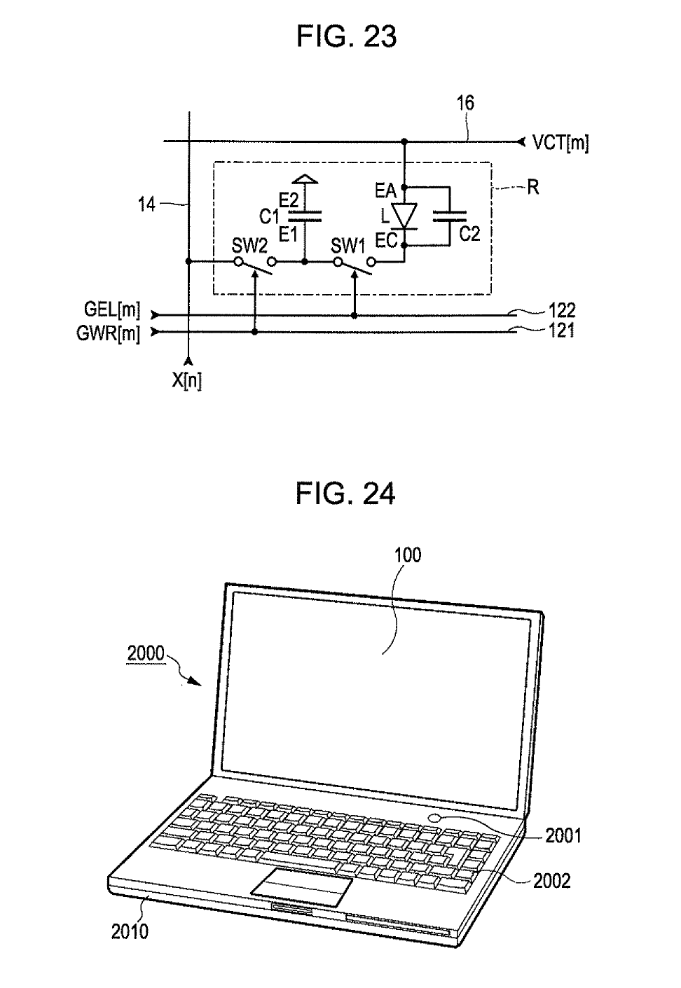

In the foregoing embodiments, the potential VCT[k] of the electrode EC of the light emitting element L in the pixel circuit (P, Q) is changed in the charging period PCH. However, as illustrated in FIG. 23, a pixel circuit R having a configuration in which the potential VCT[k] of the electrode EA of the light emitting element L is changed may be employed. Specifically, in the charging period PCH, the potential VCT[k] of the electrode EA of the light emitting element L in each control pixel circuit P is decreased from the potential VH to the potential VL so as to cause the capacitor C1 and the capacitor C2 to hold electric charge. As will be understood from this example, a configuration in which the potential VCT[k] of the potential line 16 is changed in the charging period PCH so that a reverse bias is applied to the light emitting element L is preferable for the aspects of the invention. The direction in which the potential VCT[k] is changed is appropriately selected in accordance with the configuration of a pixel circuit.

### (2) Modification 2

In the first to fourth embodiments, electric charge in accordance with the gradation potential X[n] is held in each of the capacitors C1 of the M pixel circuits P (the target pixel circuit PA and the control pixel circuits PB) in the n-th column in the writing period PWR. However, a configuration in which the total number and the combination of the pixel circuits P utilized so as to hold electric charge in the writing period PWR are set to be variable may be employed. The described configuration enables the amount of electric charge (luminance of the light emitting element L) supplied to the target pixel circuit PA in the first light emitting period PEL1 to be adjusted.

### (3) Modification 3

In the foregoing embodiments, a capacitor (parasitic capacitance) associated with the light emitting element L is utilized as the capacitor C2. However, a configuration in which the capacitor C2 is formed independent of the light emitting element L may be employed. That is, the capacitor C2 is comprehended as a capacitor located between the electrode EA of the light emitting element L and the potential line 16, regardless of whether the capacitor C2 is associated with the light emitting element L or is positively formed.

### (4) Modification 4

An organic EL element is just an example of the light emitting element L. The invention is applied, for example, to the light emitting device 100 in which the light emitting elements L, such as inorganic EL elements and light emitting diode (LED) elements, are arranged, like the foregoing embodiments. The light emitting element according to the aspects of the invention is a driven device of a current drive type, which is driven by supply of a current (typically, luminance is controlled).

### G: Applications

An electronic apparatus which utilizes the light emitting device 100 according to each embodiment is described. FIGS. 24 and 26 illustrate forms of the electronic apparatus in which the light emitting device 100 is employed as a display device.

FIG. 24 is a perspective view illustrating a configuration of a mobile personal computer which employs the light emitting device 100. A personal computer 2000 includes a light emitting device 100 for displaying various kinds of images, and a main body 2010 on which a power switch 2001 and a key board 2002 are placed.

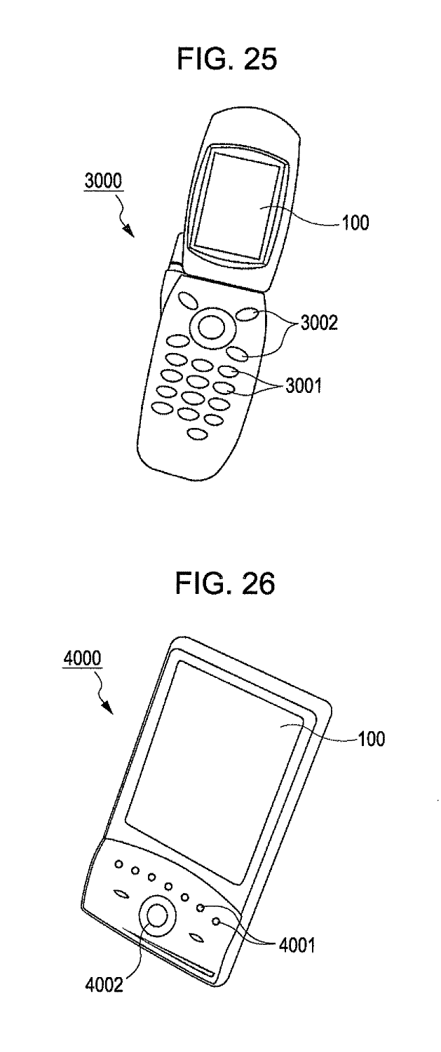

FIG. 25 is a perspective view illustrating a configuration of a cellular phone to which the light emitting device 100 is applied. A cellular phone 3000 includes a plurality of operation buttons 3001, scroll buttons 3002, and the light emitting device 100 for displaying various kinds of images. An image displayed on the light emitting device 100 is scrolled by operating the scroll buttons 3002.

FIG. 26 is a perspective view illustrating a configuration of a personal digital assistant (PDA) to which the light emitting device 100 is applied. A PDA 4000 includes a plurality of operation buttons 4001 and a power switch 4002, and the light emitting device 100 for displaying various kinds of images. Various kinds of information, such as an address book and a schedule book, are displayed on the light emitting device 100.

It should be noted that examples of the electronic apparatus to which a light emitting device according to the aspects of the invention is applied include, in addition to devices exemplified in FIGS. 24 to 26, a digital still camera, a television set, a video camera, a car navigation device, a pager, an electronic notebook, electronic paper, an electronic calculator, a word processor, a work station, a television telephone, a point-of-sale (POS) terminal, a printer, a scanner, a copier, a video player and a device with a touch panel. Applications of a light emitting device according to the aspects of the invention are not limited to displaying images. For example, a light emitting device according to the aspects of the invention is utilized as an exposure device for forming a latent image on a photosensitive drum by light exposure in an electrophotographic image forming device.

1. A method of driving a light emitting device including a signal line supplied with a gradation potential in accordance with a specified gradation, a plurality of pixel circuits each having a light emitting element which emits light in accordance with a current between a first electrode and a second electrode, and a plurality of potential lines connected to the second electrodes of the respective light emitting elements, the method comprising:
in a first light emitting period, supplying electric charge to the light emitting element of a target pixel circuit of the plurality of pixel circuits, the electric charge having been generated by supplying the gradation potential to the signal line;
in a charging period after the first light emitting period, in order for a reverse bias to be applied to light emitting elements of control pixel circuits other than the target pixel circuit of the plurality of pixel circuits, changing potentials of the potential lines corresponding to the control pixel circuits; and
in a second light emitting period after the charging period, supplying electric charge generated in the charging period to the light emitting element of the target pixel circuit.

2. The circuit according to claim 1, wherein
each of the plurality of pixel circuits includes a first capacitor having a first capacitor electrode connected to a path linking the signal line and the first electrode, and a second capacitor electrode, and
in each of the first light emitting period and the second light emitting period, electric charge held in the first capacitors of the control pixel circuits is supplied through the signal line to the light emitting element of the target pixel circuit.

3. The method according to claim 1, wherein
each of the plurality of pixel circuits includes a second capacitor associated with the light emitting element, and
electric charge held in the second capacitors of the control pixel circuits in the charging period is supplied through the signal line to the light emitting element of the target pixel circuit in the second light emitting period.

4. The method according to claim 1, wherein
in the charging period, the first electrode of each of the control pixel circuits is connected to the signal line, and
electric charge held in a third capacitor of the signal line in the charging period is supplied to the light emitting element of the target pixel circuit in the second light emitting period.

5. The method according to claim 1, wherein each of the plurality of pixel circuits includes:
a first capacitor having a first capacitor electrode and a second capacitor electrode;
a first switch disposed between the first capacitor electrode and the first electrode; and
a second switch disposed between the first capacitor electrode and the signal line, wherein
in a writing period before the start of the first light emitting period, the first switches of the control pixel circuits are controlled to be in an OFF state, and the second switches of the control pixel circuits are controlled to be in an ON state,
in the first light emitting period, the first switches of the control pixel circuits are controlled to be in the OFF state and the second switches of the control pixel circuits are controlled to be in the ON state, and the first switch and the second switch of the target pixel circuit are controlled to be in the ON state, and
in the second light emitting period, the second switches of the control pixel circuits are controlled to be in the ON state, and the first switch and the second switch of the target pixel circuit are controlled to be in the ON state.

6. The method according to claim 5, wherein, in the charging period, the first switches of the control pixel circuits are controlled to be in the ON state.

7. The method according to claim 6, wherein, in the charging period, the second switches of the control pixel circuits are controlled to be in the ON state.

8. The method according to claim 6, wherein, in the charging period, the second switches of the target pixel circuit and the control pixel circuits are controlled to be in the OFF state, and then the first switches of the control pixel circuits are controlled to be in the ON state.

9. The method according to claim 5, wherein
in the charging period, the potentials of the potential lines corresponding to the control pixel circuits are changed from a first potential to a second potential,
in the second light emitting period, the potentials are maintained at the second potential, and
in an initialization period after the second light emitting period, the potentials are changed to the first potential after the first switches of the control pixel circuits and the target pixel circuit are controlled to be in the OFF state.

10. The method according to claim 5, wherein the second switch of each of the pixel circuits is kept in the ON state from an end point of the second light emitting period to an end point of the first light emitting period corresponding to another target pixel circuit.

11. The method according to claim 1, wherein, in the charging period, the potentials of the potential lines corresponding to the control pixel circuits are changed from the first potential to a second potential which is set to be variable.

12. The method according to claim 1, wherein, among the plurality of pixel circuits, a variably set number of pixel circuits are the control pixel circuits.

13. A light emitting device comprising:
a signal line supplied with a gradation potential in accordance with a specified gradation;
a plurality of pixel circuits each including a light emitting element which emits light in accordance with a current between a first electrode and a second electrode;
a plurality of potential lines connected to the second electrodes of the respective light emitting elements; and
a drive circuit for driving each of the plurality of pixel circuits, wherein
in a first light emitting period, the drive circuit supplies electric charge to the light emitting element of a target pixel circuit of the plurality of pixel circuits, the electric charge having been generated by supplying the gradation potential to the signal line,
in a charging period after the first light emitting period, in order for a reverse bias to be applied to light emitting elements of control pixel circuits other than the target pixel circuit of the plurality of pixel circuits, the drive circuit changes potentials of the potential lines corresponding to the control pixel circuits, and
in a second light emitting period after the charging period, the drive circuit supplies the electric charge generated in the charging period to the light emitting element of the target pixel circuit.

14. The light emitting device according to claim 13, each of the plurality of pixel circuits includes:
a first capacitor having a first capacitor electrode and a second capacitor electrode;
a first switch disposed between the first capacitor electrode and the first electrode; and
a second switch disposed between the first capacitor electrode and the signal line.

15. An electronic apparatus comprising the light emitting device according to claim 13.

16. An electronic apparatus comprising the light emitting device according to claim 14.
